(19) United States
(12) Patent Application Publication
(10) Pub. No.: US 2005/0262063 A1
(43) Pub. Date: Nov. 24, 2005

(54) Method and system for website analysis

(75) Inventors: Craig Conboy, Perth (CA); Andrew Rolleston, Ottawa (CA); Derek McDougall, Kanata (CA)

Correspondence Address: HOUSTON ELISEEVA, 4 MILITIA DRIVE, SUITE 4, LEXINGTON, MA, 02421, US

(73) Assignee: Watchfire Corporation, Kanata (CA)

(21) Appl. No.: 11/114,796

(22) Filed: Apr. 26, 2005

Related U.S. Application Data
(60) Provisional application No. 60/666,074, filed on Mar. 29, 2005.

(30) Foreign Application Priority Data
Apr. 26, 2004 (CA) 2,465,421

(51) Int. Cl. G06F 7/00

(52) U.S. Cl. 707/3

(57) ABSTRACT

The invention relates generally to computers and communications, and more specifically, to a method and system for analyzing Web sites and similar data structures. Tools exist for analyzing Web sites and locating problems, or simply collecting data, but the existing tools are very limited in what they can do, generally restricting the User to a selection of predetermined “tick-box” options. The invention provides an environment in which flexible and sophisticated search parameters may be defined by the User via regular expressions and a standard language specification. This allows the User to tailor his searches to match his specific Web site policy. The “extensible scan rules” of the invention also allow logic tests and analysis to be implemented, so that the search results are far more useful and relevant to the User.

### RELATED APPLICATIONS

This application claims the benefit of the earlier filing date of U.S. Provisional application Ser. No. 60/666,074 filed on Mar. 29, 2005, as well as claims priority to Canadian application serial number 2,465,421 filed on Apr. 26, 2004 both of which are incorporated herein by reference in their entirety.

### FIELD OF INVENTION

The present invention relates generally to computers and communications, and more specifically, to a method and system for analyzing Web sites and similar data structures.

### BACKGROUND OF THE INVENTION

In recent years there has been tremendous growth in data communication networks such as the Internet, Intranets, Wide Area Networks (WANs) and Metro Area Networks (MANs). These data communication networks offer tremendously efficient means for organizing and distributing computerized data, which has resulted in their widespread use for both business and personal applications. For example, the Internet is now a common medium for operating online auctions, academic and public forums, distributing publications such as newspapers and magazines, supporting business communications, performing electronic commerce and electronic mail transactions, and offering government services.

The tools needed to offer and support such services have not kept pace with the growth and demand. The Internet is now pervasive in industrialized countries, and it is a necessity for any large organization to have an Internet presence. Some large corporate and government agencies, for example, maintain Web sites with millions of Web pages, whose content changes daily; yet they do not have the tools to efficiently manage this massive data system.

Before discussing the specific nature of these problems, it is necessary to outline the framework for discussion.

FIG. 1 presents an exemplary layout of an Internet communications system 30. The Internet 32 itself is represented by a number of routers 34 interconnected by an Internet backbone 36 network designed for high-speed transport of large amounts of data. Users' computers 38 may access the Internet 32 in a number of manners including modulating and demodulating data over a telephone line using audio frequencies which requires a modem 40 and connection to the Public Switched Telephone Network 42, which in turn connects to the Internet 32 via an Internet Service Provider 44. Another manner of connection is the use of set top boxes 50 which modulate and demodulate data to and from high frequencies which pass over existing telephone or television cable networks 52 and are connected directly to the Internet 32 via Hi-Speed Internet Service Provider 54. Generally, these high frequency signals are transmitted outside the frequencies of existing services passing over these telephone or television cable networks 52.

Web sites are maintained on Web servers 37 also connected to the Internet 32 which provide content and applications to the User's computers 38. Communications between user's computers 38 and the rest of the network 30 are standardized by means of defined communication protocols.

FIG. 1 is a gross simplification as in reality, the Internet 32 consists of a vast interconnection of computers, servers, routers, computer networks and public telecommunication networks. While the systems that make up the Internet 32 comprise many different varieties of computer hardware and software, this variety is not a great hindrance as the Internet 32 is unified by a small number of standard transport protocols. These protocols transport data as simple packets, the nature of the packet contents being inconsequential to the transport itself. These details would be well known to one skilled in the art.

While the Internet 32 is a communication network, the World Wide Web (www or simply “the Web”), is a way of accessing information over the Internet. The Web uses the HTTP protocol (one of several standard Internet protocols), to communicate data, allowing end users to employ their Web browsers to access Web pages.

A Web browser is an application program that runs on the end user's computer 38 and provides a way to look at and interact with the information on the World Wide Web. A Web browser uses HTTP to request Web pages from Web servers throughout the Internet, or on an Intranet. Currently, most Web browsers are implemented as graphical user interfaces. Thus, they know how to interpret the set of HTML tags within the Web page in order to display the page on the end user's screen as the page's creator intended it to be viewed.

A Web page is a data file that generally contains not only text and images, but also a set of HTML (hyper text markup language) tags that describe how text and images should be formatted when a Web browser displays it on a computer screen. The HTML tags include instructions that tell the Web browser, for example, what font size or color should be used for certain contents, or where to locate text or images on the Web page.

The Hypertext Transfer Protocol (HTTP) is the set of rules for exchanging files on the World Wide Web, including text, graphic images, sound, video, and other multimedia files. HTTP also allows files to contain references to other files whose selection will elicit additional transfer requests (hypertext links). Typically, the HTTP software on a Web server machine is designed to wait for HTTP requests and handle them when they arrive.

Thus, when a visitor to a Web site requests a Web page by typing in a Uniform Resource Locator (URL) or clicking on a hypertext link, the Web browser builds an HTTP request and sends it to the Internet Protocol address corresponding to the URL. The HTTP software in the destination Web server receives the request and, after any necessary processing, the requested file or Web page is returned to the Web browser via the Internet or Intranet.

A Web site is a collection of Web pages that are organized (and usually interconnected via hyperlinks) to serve a particular purpose. An exemplary Web site 60 is presented in the block diagram of FIG. 2. In this example, the Web site includes a main page 62, which is usually the main point of entry for visitors to the Web site 60. Accordingly, it usually contains introductory text to greet visitors, and an explanation of the purpose and organization of the Web site 60. It will also generally contain links to other Web pages in the Web site 60.

In this example, the main page 62 contains hypertext links pointing to three other Web pages. That is, there are icons or HTML text targets on the main page 62, which the visitor can click on to request one of the other three Web pages 64, 66, 68. When the visitor clicks on one of these hypertext links, his Web browser sends a request to the Internet for a new Web page corresponding to the URL of the linked Web page.

Note that the main Web page 62 also includes a “broken link” 70, that is, a hypertext link which points to a Web page which does not exist. Clicking on this broken link will typically produce an error, or cause the Web browser to time out because the target Web page cannot be found.

Web page 64 includes hypertext links which advance the visitor to other parts within the same Web page 64. These links are referred to as “anchors”. Accordingly, a hypertext link to an anchor which does not exist would be referred to as a “broken anchor”.

Web page 66 includes links to data files. These data files are shown symbolically as being stored on external hard devices 72, 74 but of course they could be stored in any computer or server storage medium, in any location. These data files could, for example, contain code and data for software applications, Java applets, Flash animations, music files, images, or text.

There is no limit to the number of interconnections that can be made in a Web site. Web page 68, for example, includes links to four other Web pages 76, 78, 80, 82, but it could be linked to any number of other Web pages. As well, chains of Web pages could also be linked together successively, the only limit to the number of interconnections and levels in the hierarchy being the practical considerations of the resources to store and communicate all of the data in the Web pages.

Organizations often define policies to govern the content and operation of their Web sites. Their desire is to make their Web site convenient to visitors, use their resources efficiently and maintain whatever privacy concerns they might have. For example, an organization may wish to limit the size of graphic images so that the pages can be downloaded quickly. An organization may also wish to identify and remove “broken links” 70, “broken anchors” and other problems because these may cause visitors to leave in frustration. There is therefore a need for tools which search Web sites and detect such problems which may impact quality, privacy and accessibility. Identifying these problems allows the Web site administrator to redesign his Web site as required.

Some organizations have thousands of pages on their Web sites which are altered and updated almost continuously. Thus, the tools which are used to analyze these Web sites must be capable of monitoring compliance with a corporate Website policy in a periodic and automated way, with very, little need for human assistance.

Tools do exist for analyzing Web sites and locating issues, but existing Web analysis software is very limited in what it can do. Typically, such software uses spider technology to search for matches with very specific elements, for example, searching for matches with predetermined character strings. They also use very simply User Interfaces (UIs) consisting mostly of “tick boxes” to check for the existence of common problems such as broken links and broken anchors. These existing systems find the existence of such problems and report on their existence without any sophisticated analysis.

In many cases the limited selection of fields and “tick boxes” available in commercial Web site analysis software is completely inadequate. For example, a given Web administrator may want a report that shows all the telephone numbers found anywhere on his Website, but his software limits him to searching for specific strings of numbers. Hence, his request cannot be addressed effectively with currently available scan rule software.

There is therefore a need for a means of making the analysis of data distribution systems and Web sites over the Internet and similar networks much more flexible and effective. Such a system should be provided with consideration for the problems outlined above.

### SUMMARY OF THE INVENTION

It is therefore an object of the invention to provide a method and system which obviates or mitigates at least one of the disadvantages described above.

As noted above, existing Web analysis systems are very limited in what they can do. Typically, they use spider technology to search for matches with very specific elements, for example, searching for matches with predetermined character strings. These existing systems find the specific character strings and report on their existence without any further analysis.

The method and system of the invention allows problems to be defined using “extensible scan rules” rather than simple tick boxes. The extensible scan rules use regular expressions, not unlike scripts and other high level language code, which define the search terms and are interpreted to perform the defined searching and analysis. These extensible scan rules are very flexible and can be tailored to accommodate specific Website policies, analyzing Websites to measure the level of compliance with an organization's corporate policies. As well, these extensible scan rules can incorporate logic tests and analysis, so that rather than producing raw data, much more pertinent reports are generated.

One aspect of the invention is broadly defined as a method of Web site analysis comprising the steps of: establishing parameters for search and analysis of a Web page, including customized search rules, formatted according to a defined language specification; analyzing said Web page to identify structure and content issues, and collect data, including executing said customized search rules; and generating a report on the results of the analysis.

Another aspect of the invention is defined as a system for analyzing a Web site, the system comprising: a Web server; a Content Analysis server; and a communication network for interconnecting the Web server and the Content Analysis server; the Web server supporting the Web site; and the Content Analysis server being operable to: establishing parameters for search and analysis of a Web page, including customized search rules, formatted according to a defined language specification; analyzing the Web page to identify structure and content issues, and collect data, including executing the customized search rules; and generating a report on the results of the analysis.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 presents a physical layout of an exemplary data communication network as known in the prior art;

FIG. 2 presents a block diagram of an exemplary Web site architecture, as known in the art;

FIG. 3 presents a flow chart of a method of Web page analysis in a broad embodiment of the invention;

FIG. 4 presents a flow chart of an exemplary method of Web site analysis in an embodiment of the invention;

FIG. 5 presents an exemplary format to report on pages with “Broken Links” in an embodiment of the invention;

FIG. 6 presents a block diagram of an exemplary software architecture for performing Web site analysis in an embodiment of the invention;

FIG. 7 presents an exemplary user interface (UI) for the entry of extensible search rules in an embodiment of the invention; and

FIGS. 8 through 39B present blocks of XML instructions for implementation of various Web site analysis functions in an embodiment of the invention.

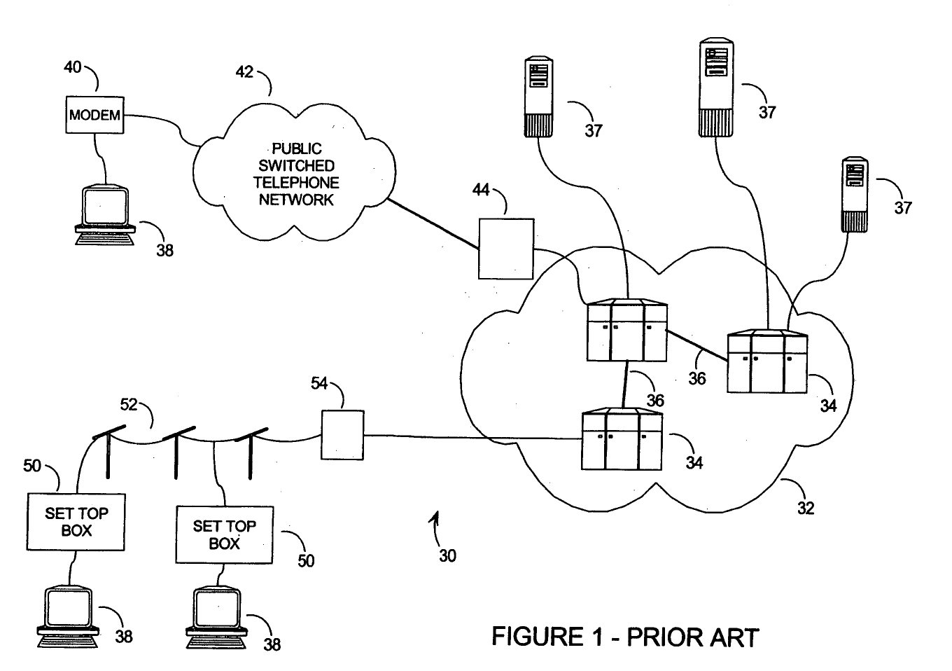

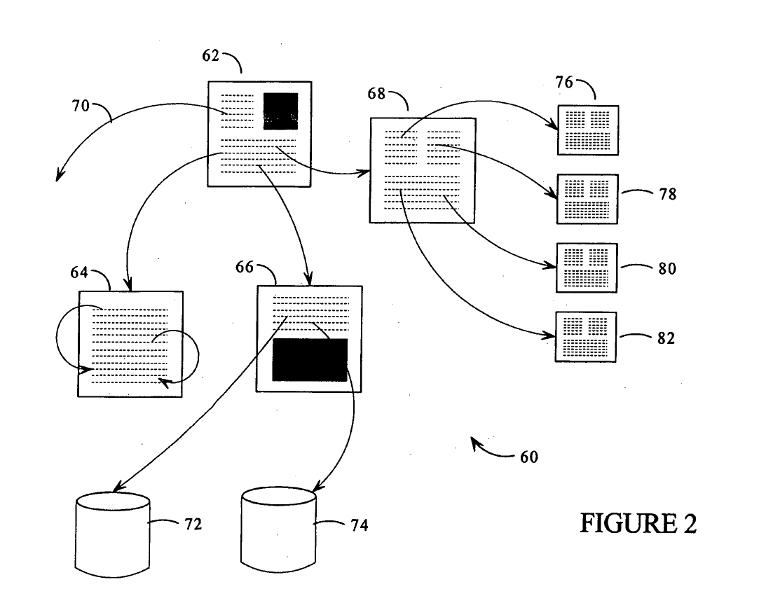

### DESCRIPTION OF THE INVENTION

As noted above, Web sites are becoming larger and larger, and the rate at which their content is being changed is ever increasing. Rather than the simple Web sites of a few years ago, which contained little more than background and content information on 6-10 pages, that changed on a monthly or annual basis, it is now quite common for Web sites to have hundreds of thousands of Web pages that change on almost a daily basis such as newspaper Web sites. Other Web sites, such as those operated by governments or large corporations, may even have millions of Web pages. Software tools simply do not exist to monitor and manage such Web sites in an effective and efficient way.

Existing technologies have attempted to solve the problem through “scan rules”, which examine Web page content for the presence (or absence) of specific text or patterns. A report showing all the Web pages that contain the specified text or pattern is produced by such “scan rules” software.

For example, existing scan rule software might have a “tick box” and entry field which allows one to search for a certain phone number on a Website. In such a case, the scan rule would allow the entry of a specific set of characters, such as “832-4448”, for example. Searching for multiple sets of characters in such an environment would require that multiple runs be performed, one for each telephone number. The use of the invention however, allows multiple telephone numbers to be searched in a single run, or even to have all seven digit numbers be located, matching the pattern “###-####”, without any reference to specific character sets. This is possible because the invention allows the user to craft dedicated search instructions using the extensible scan rules. That is, he is not bound by whatever search fields and tick boxes the creator of the commercial “scan rules” software decided to include in his software application.

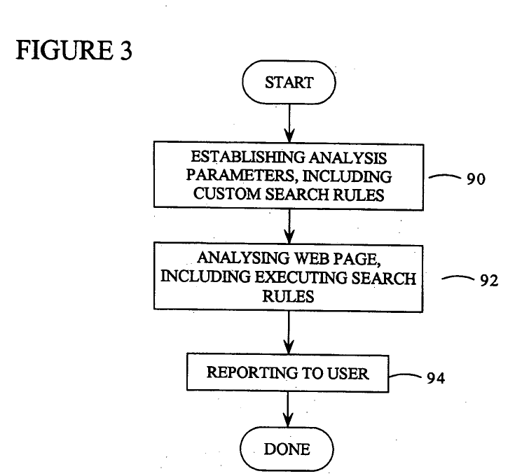

FIG. 3 presents a flow chart of a methodology which allows such large and complex Web sites to be maintained and analyzed in a far more efficient and practical manner than done in the past. Specifically, this figure presents a method of unambiguously specifying the compliance criteria corresponding to a Web site policy, and analyzing a Web page. It provides an automated system for interpreting compliance criteria in order to determine the compliance of a Web site to the Web site policy and it allows the incorporation of logic and data processing abilities into the customized search rules (i.e. the extensible scan rules).

As will be described hereinafter, this methodology will generally be applied to Web sites with large numbers of Web pages, but could be applied to Web sites of any size. Hence, FIG. 3 refers to the analysis of a single Web page.

This methodology begins at step 90, where the search and analysis parameters are established. Generally, this step will consist of identifying the Web page or pages to be analyzed, and the analyses that are to be performed. As part of this step, customized search rules, formatted according to a defined language specification, are established by the User.

The way in which the customized search rules are entered and edited will depend on how the invention is implemented. In the preferred embodiment described hereinafter, the customized search rules are entered in XML code which is interpreted at run time. However, customized search rules could also be implemented in many other ways including for example: Java applets, Visual Basic scripts, a custom language or any high level code. The customized search rules may be entered using any manner of text editor, GUI (graphic user interface) or code management tool.

As well, the search parameters may be entered immediately prior to run time, generated well in advance and stored in memory, or provided by a third party as ready-to-use tools.

At step 92, the targeted Web page or pages are analyzed in accordance with the search and analysis parameters to identify the corresponding Web page structure and content issues. As noted above, these issues may include such things as identifying broken links, broken anchors and slow pages. Many other issues are known in the art including missing Alt text, spelling errors, forms, compliance with accessibility guidelines, cookie handling, third-party links and P3P compact policies. A more comprehensive list of issues is included hereinafter.

The invention may also be used to collect data, such as identifying URLs to be added to a list of URLs to be spidered, or it may be used to generate Web application security tests.

As well, as part of this step, the customized search rules are executed which provides for much more comprehensive searching and analysis. This execution can be performed in many ways, which will generally be determined by the way in which the customized search rules were developed and entered at step 92. Typically, this will require the use of a compiler or interpreter, which may process the code in advance or at run time.

Once the data are obtained and analyzed at step 92, the results are collated and reports generated at step 94. The reports of course, will be driven by the parameters of the search as determined at step 90.

Many different reports may be generated. Content issue data would generally be collected and indexed by Web page, and thus, reporting by Web page is the most logical way to report. However, content issue data could also be sorted by the nature of the content issue. Certain content issues, for example, might be considered “fatal” content issues, such as pages which contain errors which might cause browsers to crash, or pages which are not linked to any other page. Other content issues might be considered to be less significant such as Web pages which contain large images which are slow to download, or Web pages which link to outside Web pages which have become outdated.

Many GUI-based (graphic user interface-based) data management and reporting tools exist, so it is quite straightforward to tabulate this data and produce the desired reports. Reports may simply be presented to the Web administrator on a display screen, printed out, or stored for future reference.

The invention can be implemented on the foundation of existing scan software. Many such systems are commonly available including for example: Watchfire WebXM™, Coast WebMaster™, Keynote NetMechanic™, Maxamine Knowledge Platform™, SSB InFocus™, HiSoftware AccVerify™ and Crunchy Page Screamer Central™. The actual work that would be required to implement the invention will depend on the tools being used, and the design philosophy of the existing scan software, but would be clear to one skilled in the art from the teachings herein.

Thus, the invention of FIG. 3 addresses the problems in the art. Given large, complex Web sites and a possibly large number of issues with the content of those Web sites, the invention provides an effective way of analyzing and presenting the content of the Web sites and the issues that the Web sites contain.

The invention replaces the traditional spider-based Web analysis architecture with one in which the Web-analysis is driven by a customizable, logic-based architecture. The logic layer is fully configurable by the user, so that an endless variety of new and more sophisticated analyses can be performed. For example, the invention can:
identify areas of non-compliance with policy that could not previously be discovered, because of the flexibility in specifying what is being searched for;
it defines a language for describing the criteria for compliance to a policy. This language allows a much broader range of policies to be described than was previously possible with other technologies;
it can contain logic, allowing complex compliance/non-compliance decision-making and separation of irrelevant data from relevant data;
it may access many types of data besides traditionally targeted Web page content: cookies, headers, other Web pages, etc., to determine compliance/non-compliance. This is possible because the invention does not have the predetermined restrictions that existing scan tools have;
there is greater flexibility in the format and content of reports that are generated because logic can be used to tailor or modify the collected data; and
the extensible scan rules may be created and deployed in the field, allowing for great flexibility (as opposed to compiled code such as dll's or exe's).

Further advantages will become clear from the description of other embodiments of the invention which follow.

### DESCRIPTION OF PREFERRED EMBODIMENTS OF THE INVENTION

The preferred embodiment of the invention provides:
a system for authoring compliance criteria for Web site policy;
an extensibility mechanism that allows the extensible scan rules to adapt to Web site policy diversity;
the ability to author extensible scan rules in a text editor (interpreted, not compiled code); and
the ability to specify the layout and content of reports in the extensible scan rules.

Extensible scan rules have been integrated into Watchfire's WebXM scanning product (the subject of the co-pending U.S. patent application Ser. No. 10/361,948, the contents of which is incorporated herein by reference).

To assess an organization's Web site policy compliance, the relevant aspects of the policy need to be expressed as extensible scan rules or “XRules”. In this embodiment of the invention an XRule is an XML document that is formatted according to rules laid out in the XRules Language Specification. An XRule expresses an aspect of Web site policy in an unambiguous, machine-readable manner.

The content of the organization's Website is discovered and processed by the WebXM “scan engine”. The scan engine, through a user interface, can be provided with XRules that are to be applied to the Website. The XRule Runtime interprets the XRule in order to assess the compliance or non-compliance of each page. For each page the scan engine processes, when there is an enabled XRule that applies to the region, the XRule Runtime executes the XRule. When the XRule is executed, it assesses compliance and can insert data into the database. This data is used to produce a report detailing the Website's compliance to the aspect of Website policy expressed by the XRule.

XRule functionality may be extended by creating “Extension Operations” and “Extension Functions”. To deploy an XRule that uses extension operations, the XRule XML needs to be specified and the assembly (dll) containing the extension operations must be placed in a specific directory on each scan server. The XRules Language uses a mixture of declarative and functional programming styles to describe compliance criteria. The building blocks of the language are the Core Operations and Core Functions. Some Core Operations provide functional programming capabilities, such as:
Variables: xsr:variable, xsr:update-variable
Repetition: xsr:for-each
Conditional logic: xsr:if, xsr:choose
Regular Expressions: xsr:analyze-string

Some Core Operations use a declarative programming style to describe aspects of the policy or retrieve external data:
Describing the policy: xsr:annotation
Controlling report appearance: xsr:specify-column-headings
Accessing the Web: xsr:http-request

Some Core Functions support regular expression operations:
Testing for match: xsr:matches
String replacements: xsr:replace
Splitting string into substrings: xsr:tokenize

Some Core Functions provide access to data collected by the scan engine:
Obtaining HTML: xsr:retrieve-html( )
Obtaining Text: xsr:retrieve-text( )
Obtaining Form HTML: xsr:retrieve-formhtml( )
Obtaining Links on Page: xsr:retrieve-links( )
Obtaining Cookies: xsr:retrieve-cookies( )

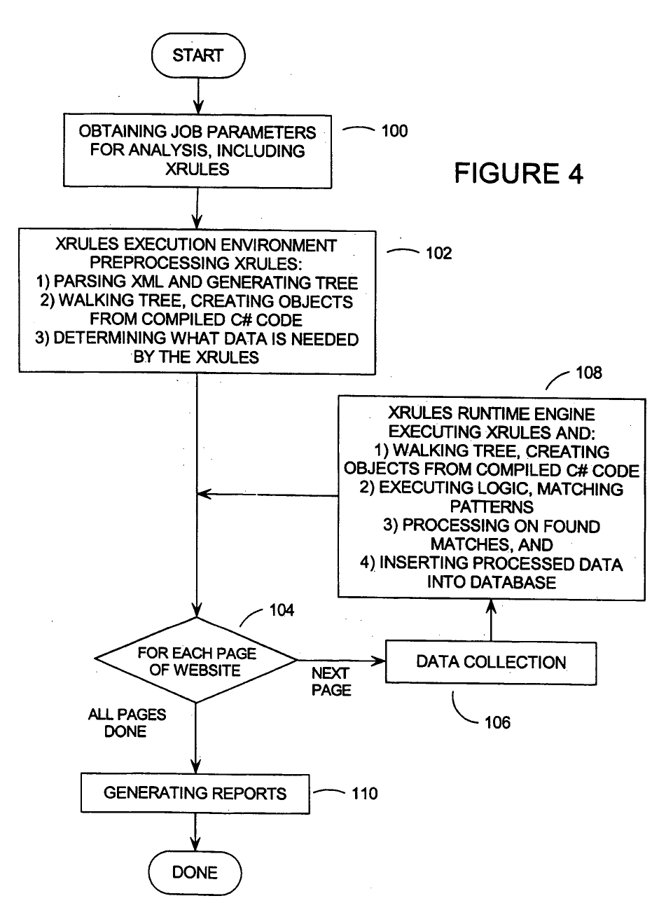

A specific method of implementing the invention is presented in the flow chart of FIG. 4. The invention can be implemented in many different ways. For example, it could be deployed in a centralized service bureau configuration, or as a decentralized hosted service. Many options and alternatives are described hereinafter, but it would be clear to one skilled in the art that many other variants follow from the teachings herein.

At step 100, the parameters for analysis are collected. This may consist of the User entering entirely new search information, or simply calling a stored file that was generated earlier. The analysis parameters will generally include:
the address of the targeted Web site or Web pages to be analyzed;
standard scan data of interest;
XRules;
any report parameters, including fields, titles, etc.; and
any other standard parameters used in scanning tools, such as defining how URLs are to be normalized (some Web sites will direct user's to servers in close geographic proximity, or use multiple servers which are load balanced. “Normalizing URLs” refers to how these multiple servers are handled in the XRules reports.)

In this embodiment, the extensible scan rules are written in XML (extensible markup language), using a standard text editor. XML is a standard, software development language-independent text format for representing data. XML is a markup language in the same sense as Standard Generalized Markup Language (SGML), and Hyper Text Markup Language (HTML). XML is desirable in this application because it can easily be converted to executable object-oriented code.

Object-oriented software languages are an attempt to mirror the real world, in the sense that “physical” Objects are identified, and certain functionality is associated with each given Object. Software Objects are not easily portable, so it is common to convert software Objects to markup language code for transmission over the Internet, re-assembling the Objects when they are received—a number of protocols have been developed to support the communication of XML data over the Internet. It is much easier to transmit database queries and structures over the Internet using XML (extensible Markup Language) code rather than, for example, Java Objects.

XML documents are usually prepared following a set of syntax rules called a “schema”. A given group of XML documents all follow the same XML schema, which is an XML document itself, so that they are compatible with one another. The syntax rules may, for example, indicate what elements can be used in a document, define the order in which they should appear, define which elements have attributes and what those attributes are, and identify any restrictions on the type of data or number of occurrences of an element. Schemas can be custom designed, though many schema are established by standards groups for general areas of application.

Once the parameters have been established an analysis of the Web site or Web pages can now begin at step 102. Clearly, this step flows logically from the parameters set at step 102 and the nature of the analysis being performed.

This step requires that the XRules Execution Environment “preprocess” the XRules by performing the following:
parsing the XML document and generating a path tree;
walking the path tree, creating objects from compiled c# code; and
determining what data are needed by the XRules.

The XML document can be parsed using an XML parser as known in the art, which generates a tree of XML nodes. XPath queries are then used to collect the desired information from the XML tree of nodes. Again, XPath is known in the art and this is standard practice for collecting information from XML documents.

The XPath queries are used to collect the data needed to affect the desired mapping. Once this data has been collected, the corresponding pre-compiled or interpreted C# code can be populated with data.

While doing this, the application builds a listing of data that will be searched for when the targeted Web site or Web page is analyzed.

The loop through steps 104, 106 and 108 then searches through each Web page specified in the analysis parameters at step 100. At step 106, the desired data for each page in the current Web page is collected, and at step 108, the XRules Runtime Engine is executed on the collected data.

Step 108 generally consists of the following substeps:
walking the path tree, creating objects from compiled c# code;
executing logic, matching patterns;
processing on found matches; and
inserting processed data into database.

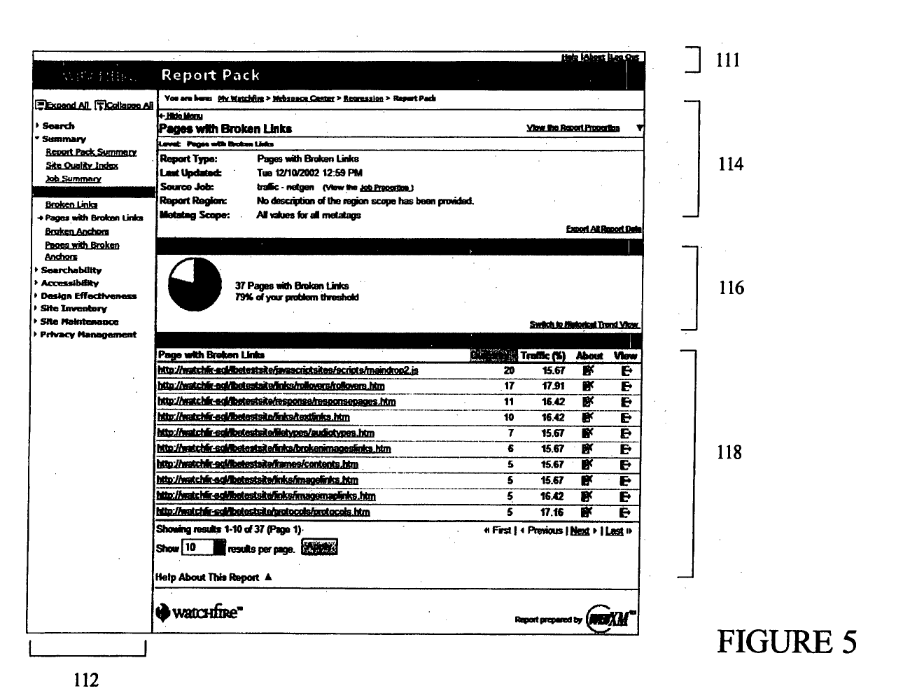

Once it has been determined at step 104 that all of the targeted pages have been analyzed, processing passes to step 110, where reports are generated. Reports can be generated and presented in many formats, including for example, that of FIG. 5. This display uses a Web browser as an interface application, and was written in XML. Other display formats and software could also be used.

FIG. 5 presents a graphic display of a “Pages with Broken Links” report, with a set of Help, About and Logout Tabs 111, which are standard for all of the reports in this embodiment of the invention. It also includes four information frames:
1. an index frame 112 which lists headings for each Web page in the software package of the invention;
2. a “report properties frame” 114 which lists the properties of the current report, the “Pages with Broken Links” report;
3. an “overview frame” 116 which summarizes the results of the report; and
4. a “details frame” 118 which breaks down the results of the report for each Web page in the analysis.

The index frame 112 is common to all of the reports. By clicking on different headings the Web administrator can expand the entry identifying all of the subpages linked to the Web page heading that he has clicked on. Also at the top of this index frame 112 are two icons, one labelled “expand all” and the other labelled “collapse all”; clicking on the “expand all” icon shows the headings for all of the Web pages in the hierarchy and clicking on the “collapse all” icon reduces this list only to the main headings.

Note that FIG. 5 presents an expanded list of the reports under the “Site Defects” heading in the index frame 112, specifically, reports titled: Broken Links, Broken Anchors, and Pages with Broken Anchors. Other similar reports could also be entered under this heading.

The report properties frame 114 lists the relevant properties and parameters as set by the Web administrator for this particular report. As shown in FIG. 5 this embodiment of the invention includes the title for the report (“Pages with Broken Links”), the date on which this report was last updated, the source of the analysis data (along with a link to a page containing all of the parameters and preferences for the analysis), the scope of the data and which scope of metatags were considered in the analysis.

In this embodiment, the overview frame 116 provides three pieces of information:
1. a pie chart which shows the percentage of the Web pages in the scope of the analysis which include content issues;
2. the absolute number of Web pages with the content issues; and
3. the percentage of Web pages that meet the problem threshold (i.e. In some reports it may be of interest to only report on pages which have a certain minimum number of warnings or defects).

As shown in FIG. 5, the details frame 118 presents five columns of information:
1. a list of the Web pages that contain broken links;
2. the number of broken links contained by each of these pages;
3. the percentage of total site traffic directed to those pages over the specified historical period for traffic data use;
4. an “About” column which provides an iconic representation of the overall quality of the page. This measure is derived from the total number of defects and the severity of that particular Web page; and
5. a column containing a “View” icon.

Clicking on various elements in the table will result in new views of the data:
1. clicking on either the URL, Quantity, Traffic, or About columns will cause the data to be resorted in accordance with the heading that has been struck;
2. clicking the URL for a page will access a detailed report of all of the broken links on that page;
3. clicking the icon in the “About” column will access a detailed report of all of the characteristics of, and defects on that Web page; and
4. clicking the icon in the “View” column will open the specified Web page in a new Web browser window.

The reports generated at step 110 may be printed out, stored in data files, or presented to the Web administrator graphically, for example, using HTML, ASP or XML documents. (HTML and XML are markup languages which are well known. ASP or “Active Server Pages”, is a script-based, server-side Microsoft technology for dynamically created Web pages).

Reports can be produced to detail a very large number of content issues and Web page characteristics. The content issues and Web page characteristics may include the following:

1. Content Issues:
a. Broken links—links to resources that cannot be found;
b. Broken anchors—links to locations (bookmarks) within a page that cannot be found;
c. Spelling errors—spelling errors, with respect to a language dictionary and/or a domain terminology dictionary;
d. Links to local files—resources whose location is defined with respect to a local network, and that are not accessible by an external Web browser;
e. Missing keywords—resources that are missing keywords cannot be indexed by many search engines;
f. Duplicate keywords—pages that use the same keyword multiple times may be rejected by some search engines;
g. Missing titles—pages missing a title cannot be indexed by many search engines;
h. Duplicate titles—identical titles that are used on more than one page cannot be catalogued by many search engines;
i. Missing descriptions—pages missing descriptions may not be as effectively indexed by many search engines;
j. Images missing Alt text—images missing Alt text are an accessibility issue;
k. Images missing height or width attributes—images missing height or width attributes force the web browser to infer the proper layout of a pages. This consumes system resources and affects the visitor experience;
l. Deep pages—content that is deeply embedded in the structure of a web site (i.e., many clicks away from the home page) are difficult for visitors to navigate to;
m. Slow pages—pages whose total download size (the page itself plus any images, applets, and other downloadable components) exceed some size specified by the Web administrator which may be prohibitive to download over slow connections;
n. Warnings and redirects—pages that either redirect the user to other content or return a server warning;
o. Browser compatibility—pages whose markup elements may not be interpreted properly by one or more types or versions of Web browser;
p. Cookie handling by browser privacy settings—cookies that may be rejected under default privacy settings in popular Web browsers;
q. Missing privacy links—pages that do not have a link to a privacy statement may expose website owners to legal liability;
r. Forms on pages missing privacy links—pages with forms but that are missing links to a privacy statement may be collecting personal information without giving visitors access to a privacy statement; this may expose website owners to legal liability;
s. Forms with controls that are prepopulated—form controls that are pre-populated can expose website owners to legal liability;
t. Forms by submit method (GET or POST)—forms using the GET submit method transmit data non-securely; this may expose Web site owners to legal liability;
u. Forms by page security level—forms on pages with low or no security may transmit data that is easily decrypted; this may expose Web site owners to legal liability;
v. Cookies—cookies set by a third-party may use personal information inappropriately, and may expose Web site owners to legal liability,
w. Web beacons—Web beacons are a common way of having one site ‘spy’ on the visitors to a third-party site. This may expose Web site owners to legal liability;
x. P3P compact policy—cookies on pages without a P3P compact policy may be rejected by web browsers, and so may affect a visitor's experience;
y. Third-party links—third-party links may lead to inappropriate content, and may expose site owners to legal liability; and
z. adherence to accessibility guidelines (e.g., US Section 508; W3C WCAG 1.0, 2.0, etc.; user-specified guideline)—ensuring that pages comply with accessibility guidelines may be mandated by local legislation, and is good business practice

2. Content Characteristics
a. Website domains—the domains that are internal to or that can be linked to from a website
b. File (MIME) types in use—the different types of content that are in use across a website
c. Image inventory—images that are in use across a website
d. File inventory—files that are in use across a website
e. Multimedia content—multimedia content that is in use across a website
f. Server-side image maps—server-side image maps affect page performance, and are a largely deprecated web-technique
g. Style sheets in use—style sheets in use across a website
h. Pages using style sheets—pages that make use of style sheets
i. Old pages—content that is old, and may be in need of updating
j. New pages—content that is new, and may be in need of review
k. Small pages—pages that may be missing content, and so are of no value to site visitors
l. Metadata inventory—metadata elements that are in use across a site

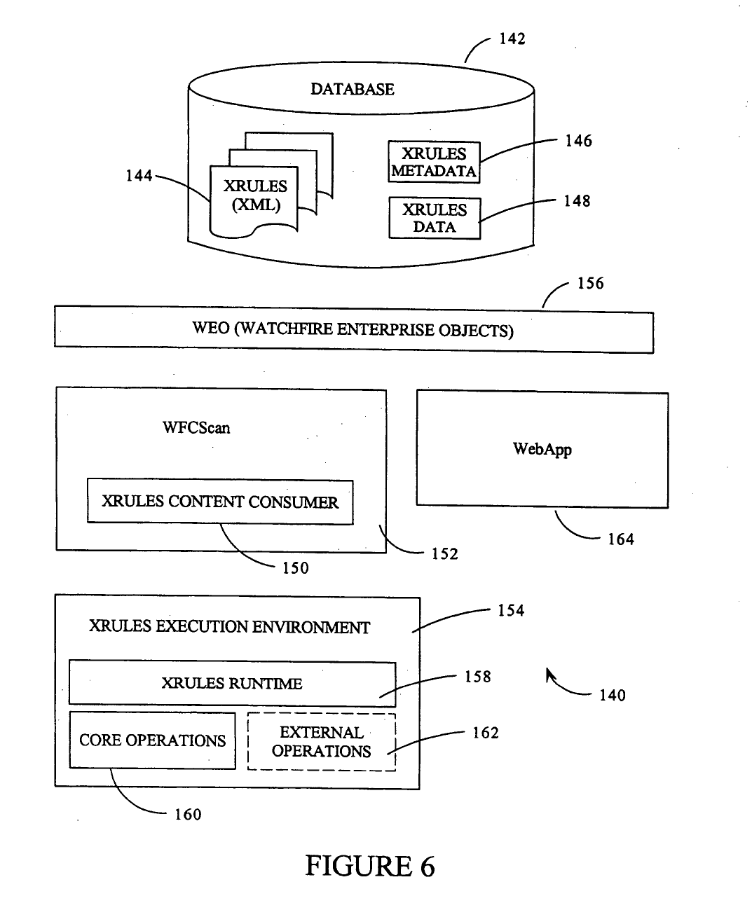

FIG. 6 presents a block diagram of the software architecture 140 for the preferred embodiment of the invention.

The software architecture 140 includes a database 142 which provides storage for the XRules 144, which are XML documents. The database also stores XRules Metadata 146, for instance the column headings to display in a report. The database also stores XRules Data 148, which is the data collected by the XRules and used to create the compliance reports. The database 142 may comprise any readable/writable storage media or combination of different readable and writable media including random access memory (RAM), optical media (such as CD Roms) and magnetic media (such as hard drives).

The XRules Content Consumer 150 provides the interface between the scan engine WFCScan 152 and the extensible scan rules in the XRules Execution Environment 154. Data collected by the scan engine WFCScan 152 is provided to the XRules Execution Environment 154 via the XRules Content Consumer 150.

The WEO is the set of Watchfire Enterprise Objects 156. It provides the interface between the targeted application (WebApp 164) and the Website analysis system.

The XRules Execution Environment 154 preprocesses the set of XRules and maintains state between XRule executions. For each page processed by the scan engine 152, the XRules Runtime 158 executes the applicable XRules. As the XRules Runtime 158 navigates the XRule XML, it invokes the operations and functions as specified in the XRule XML. Operations and functions are objects implemented in compiled code that are invoked dynamically from the XRule. Operations and functions can retrieve data collected by the scan engine 152, can perform processing on that data, can cause data to be stored in the database and can control which portions of the XRule are executed. WebXM provides a set of “Core Operations” 160, but “External Operations” 162 can also be supported. XRules written to use only core operations 160 can be deployed most easily since only the XRule XML needs to be specified in the WebXM User Interface.

Exemplary XRules

A number of exemplary XRules are described hereinafter, including, for example:
a SQL Injection XRule, for pages containing a form, which makes additional requests for the page with a SQL payload in the post data and detects unexpected responses;
a cross-site scripting (XSS) XRule which makes additional requests for the page with a JavaScript payload and detects the presence of the JavaScript payload in the response page;
a Protected Resources XRule which identifies all pages that require credentials by making a separate HTTP request to the page without any credentials and examining the response;
a Session Timeout XRule which gathers a list of URLs and posts data (including the session cookies) and after a specified duration re-requests each of the pages and checks the response to ensure the session has been expired; and
a Table Classification XRule which contains a heuristic that distinguishes between “data tables” and “layout tables” and contributes results to existing accessibility reports.

Related Documents

Other documentation which may assist in the understanding of and implementation of the invention include the following:
XPath 2.0 Specification: http://www.w3.org/TR/xpath20/
XPath 2.0 Functions and Operators: http://www.w3.org/TR/xquery-operators/
XSLT 2.0 Specification: http://www.w3.org/TR/xslt20/

Microsoft .Net Regular Expressions syntax references:
http://msdn.microsoft.com/library/default.asp?url=/library/enus/cpgenref/html/cpconregularexpressionslanguageelements.asp

Common regular expressions library: http://www.regxlib.com/Search.aspx

Features

Ability to Find Issues Using Regular Expressions

XRules can use regular expressions to find any content that can be matched with a regular expression pattern. This is considerably more powerful than the current text matching.

Ability to Specify Additional Logic

Sometimes regular expressions will be sufficiently expressive to alone find the issues that need to be reported. An example of this is the regular expression in the previous section that finds only tables with width>=760.

However, sometimes the regular expression will find a potential issue that needs further evaluation to determine whether or not it should be reported. In order to perform these evaluations, XRules supports some basic programming constructs, such as conditional logic, variables and repetition.

For example, a regular expression can be defined to report all of the RGB (red, green, blue) colors used in a Web page's HTML code. However, logic can be used to check whether each found color is in a list of acceptable colors, and report any colors which are not.

Ability to Generate Reports

XRules includes some basic report definition and generation functionality. Existing scan rules do not require a custom report be created; XRules offers similar functionality. For simple XRules, professional services can paste the XRule XML into the User Interface, enable the scan rule and do a Create and Package All to create the report defined by the XRule.

The basic report definition functionality XRules provides, may not meet all customer reporting requirements. In these cases, the role of the XRule will be to populate the database with the desired data, and traditional techniques for creating custom reports will be used to create the report.

Provide Convenient Programming Model

This embodiment of the invention:
does not require compilation or a specialized development environment;
can be easily shared by email; and
can be leverage existing technical skills.

An XML-based format originally designed for describing security checks will be adapted to become XRules. This format relies on XPath in the same way that XSLT relies on XPath; so the XRules programming model will look familiar to Professional Services people who have worked with XSLT to customize reports.

Provide User Interface for Adding/Editing XRules

The user interface for the existing Watchfire scanning software is largely unchanged by the addition of the extensible scan rules.

The Rule Type drop down in Custom Rule Type and Options will display in its list the XRule rule type if:
a) the string “XRule&” is added to the url to the page after the ‘?’
b) the rule being edited is an XRule

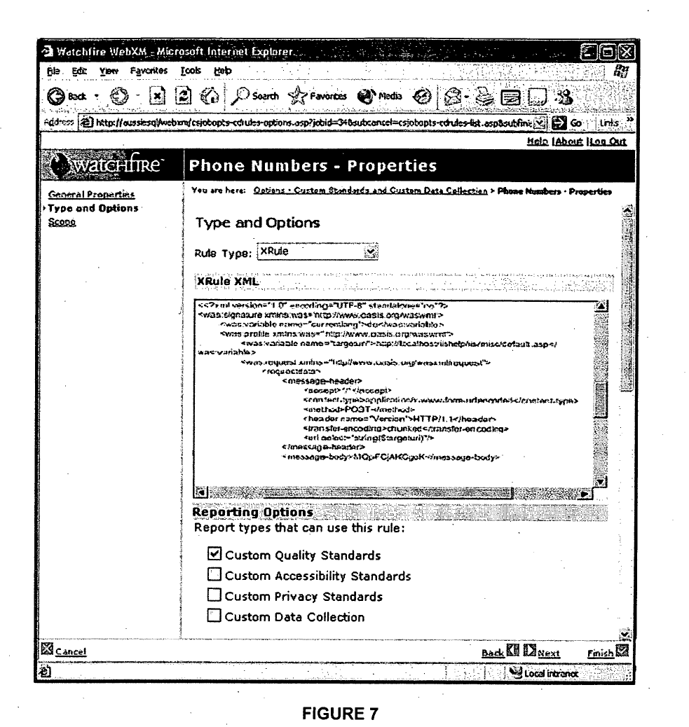

When a rule type of XRule is selected, a multiline text box is displayed. The XRule XML can be entered or pasted into this text box, or is displayed there when editing an existing XRule. When Back/Next/Finish is selected, the XRule will be validated against an XML Schema and highlighted if invalid. An exemplary User Interface (UI) for implementing such functionality is presented in FIG. 7.

Note that validation against an XML Schema will not guarantee that (a) the XRule will run without errors or that (b) the XRule will do what the author intended. Unfortunately, those types of errors can only be detected by running the scan and examining the error log.

Create and Package All will create a report named according to the rule name, and in the selected report categories, just as is done for other custom rules.

Provide XRules Diagnostics

When execution of an XRule terminates unexpectedly, the following data is dumped into the WebXM log to assist the XRule developer's debugging efforts:
the last operation (XML element) executed successfully;
the current state of the XRule XML tree (including the in-memory updates); and
the stack trace.

XRule by Mime-Type

It is preferable to declare which mime-types an XRule is applicable to so that they are not processed indiscriminately against all text.

Programming Language Selection

The XRule runtime and operations were implemented as .Net assemblies that interoperate with COM in both directions.

Doing this in C#/.Net is a more complicated from a deployment perspective then doing this in C++/ATL. The decision to do it in C#/.Net is justified as follows:

The .Net XML/XPath framework allows extensions we need that cannot be done with MSXML in C++. We need to extend XsltContext to control resolution of XPath extension functions and variables. Some of the components of the .Net version of the XSLT implementation are open API and may be overridden to create new XML based languages, like XRules. MSXML does not offer similar functionality. If MSXML is only available technology for XML/XPath, a different design approach would be required.

Pro Services will be able to further extend the XRule environment by adding new operations. It will be easier for Pro Services to create extension operations in .Net than in COM (fewer lines of code, potentially use System.Relection.Emit to dynamically generate operations from code provided in a UI.)

Interesting Note: Sufficient regular expression functionality is now available in either .Net or ATL! (CAtlRegexp class in the ATL Server Library.)

External Brand Management/External Trademark Use

XRules can handle data collection for External Brand Management report—i.e. show me pages on the Web that use my brand and contain issues. XRules can:
1) perform search against Google/Altavista (using core functionality or maybe using an extension operation);
2) use Regexp to parse out URLs; and
3) add found urls to scan

Combined with the External Scan Rules functionality, that is all that is required to collect the data for the report. The benefit of this approach is that if the Google/Altavista HTML format changes, we only need to email a modified version of the XRule to customers to paste into the XRule UI.

Web Linking Disclosures

Report any page that has an external link and is missing a warning message to tell the user she is leaving my site. XRule can:
1) Retrieve the number of external links the page has from the scan engine
2) Fast return if no external links
3) Otherwise, pattern match page HTML for warning message
4) Add record to database if warning message not found
5) Provide list of pages missing Web linking disclosure in a standard report
   XRules Specification

Introduction

This specification defines the syntax and semantics of the XRules language. An XRule is expressed as a well-formed XML document that conforms to the schema defined in this specification.

The term XRule is short for extensible scan rule. An XRule describes processing to be performed when a page is evaluated. The XRule language provides sufficient functionality for creating solutions for many common page evaluation problems. When core functionality is insufficient, the XRule language can be extended to perform more sophisticated processing.

Concepts

The component responsible for processing an XRule is the XRule Runtime 156, referred to here unambiguously as the runtime 158.

The role of the runtime is to navigate the XRule XML. The runtime maintains a cursor into the parsed XML tree of the XRule. When the cursor arrives on an XML element, it attempts to create and execute an Operation that corresponds to the namespace and name of the XML element. Operations are able to direct the movement of the runtime's cursor, retrieve data from the scan engine, write data to the WebXM database, and perform other processing.

The runtime is installed with a set of operations known as the Core Operations. XRules that make use only of core operations are portable; the XRule XML can be deployed alone on other WebXM installations. Extension Operations can be created to perform processing that is not possible or awkward to perform exclusively with core operations. To deploy an XRule that makes use of extension operations on another WebXM installation, the XRule XML must be deployed and the dll containing the extension operations must be installed on each content scan server.

The XRules language shares many syntactic similarities with XSLT, as both languages leverage XPath extensively. The runtime provides an XPath evaluation facility that is used by operations. XPath may be extended by adding new functions. XRules provides a number of XPath extension functions, and it is possible to create new XPath extension functions for use within XRules.

Namespaces

The namespace of an XML element is used by the runtime to load the appropriate Operation.

Operations are contained in dll's. The namespace of the XML element must identify the dll to load. For instance, the core operations are contained in a dll named WFCXsrOps.dll. The namespaceUri for the core operations is declared as follows: xmlns:xsr=‘urn:coreops-watchfire-com:assembly:WFCXsrOps.dll’

All namespaces within an XRule that are intended to identify assemblies (dll's) containing operations or XPath extension functions must conform to the following pattern:
urn:[a-zA-Z0-9-] {2,32} :assembly:(.*)

Informally, the ‘urn:’ identifier, followed by between 2 and 32 alphanumeric characters and dashes, followed by the token ‘:assembly:’ followed by the unqualified name of the dll. In addition, all the other restrictions for Uniform Resource Names apply (although these are unlikely to be encountered) per RFC 2141. See http://www.fags.org/rfcs/rfc2141.html.

The dll must be placed in the <install-directory>\Watchfire\WebXM directory on each WebXM content scan server.

Extensibility

XRules provides two hooks for extending the language, one hook for extending the set of operations and one hook for extending the set of functions used in XPath expressions. These hooks are both based on XML namespaces.

Extension operations are created by extending the Operation abstract base class contained in the WFCXsrRuntime assembly. Operations can be written in any .Net programming language.

XPath extension functions are created by implementing the System.Xml.Xsl.IXsltContextFunction interface. XPath extension functions can be written in any .Net programming language.

Operations and functions must be packaged into an assembly (a dll). Also present in the assembly must be a class implementing the IExtensionFactory interface. The IExtensionFactory class is instantiated by the runtime and is used by the runtime to obtain instances of operations and functions contained within the assembly.

XRules Document Structure, Lifecycle and Concurrency

An XRule document contains three executable sections, each one invoked at a different stage of the XRule's lifecycle.

The initialize section is invoked before any pages are processed. The initialize section may be used to specify metadata about the XRule's results such as column headers and report format.

The evaluate section is invoked each time a page is ready to be evaluated by the XRule.

The finalize section is invoked when the processing of pages has been completed. The finalize section can be used to release resources and perform cleanup.

In the preferred embodiment, the XRules are invoked in a multithreaded environment. Each scanning thread has its own instance of the XRules runtime. Each instance of the XRules runtime operates completely independently of the other instances. The initialize and finalize sections of the XRule are processed once for each scanning thread. Therefore any processing contained in initialize or finalize will be executed multiple times when multiple scanning threads are used. The evaluate section will be processed for each page that a scanning thread processes; when there are multiple scanning threads, no one instance of the XRule will process all of the pages in the scan.

Core Operations

Terminology

For XRules, a sequence constructor is sequence of sibling nodes in the XRule that can be evaluated by the runtime.

A sequence expression is an XPath expression that evaluates to a sequence of items.

When a sequence constructor is evaluated, the runtime keeps track of which nodes are being processed by means of a set of implicit variables referred to collectively as the focus. More specifically, the focus consists of the following three values:

The context item is the item currently being processed. An item is either an atomic value (such as an integer, date, or string), or a node. The context item is initially set to the element currently being evaluated. It changes whenever instructions such as xsr:for-each or xsr:analyze-string are used to process a sequence of items; each item in such a sequence becomes the context item while that item is being processed. The context item is returned by the Xpath expression. (dot).

The context position is the position of the context item within the sequence of items currently being processed. It changes whenever the context item changes. When an instruction such as xsr:for-each is used to process a sequence of items, the first item in the sequence is processed with a context position of 1, the second item with a context position of 2, and so on. The context position is returned by the Xpath expression position( ).

The context size is the number of items in the sequence of items currently being processed. It changes whenever instructions such as xsr:for-each are used to process a sequence of items; during the processing of each one of those items, the context size is set to the count of the number of items in the sequence (or equivalently, the position of the last item in the sequence). The context size is returned by the Xpath expression last( ).

A QName is a qualified name: a local name optionally preceded with a namespace prefix. Two QNames are considered if the corresponding expanded-QNames are the same.

An expanded-QName is a pair of values containing a local name and an optional namespace URI. A QName is expanded by replacing the namespace prefix with the corresponding namespace URI, from the namespace declarations that are in scope at the point where the QName is written. Two expanded-QNames are equal if the namespace URIs are the same (or both absent) and the local names are the same.

Dynamic errors are detected by the runtime when executing the XRule and cause execution to terminate. Static errors are detected when an XRule is validated and cause the Webapp to disallow the XRule for the job.

Looping: For-Each

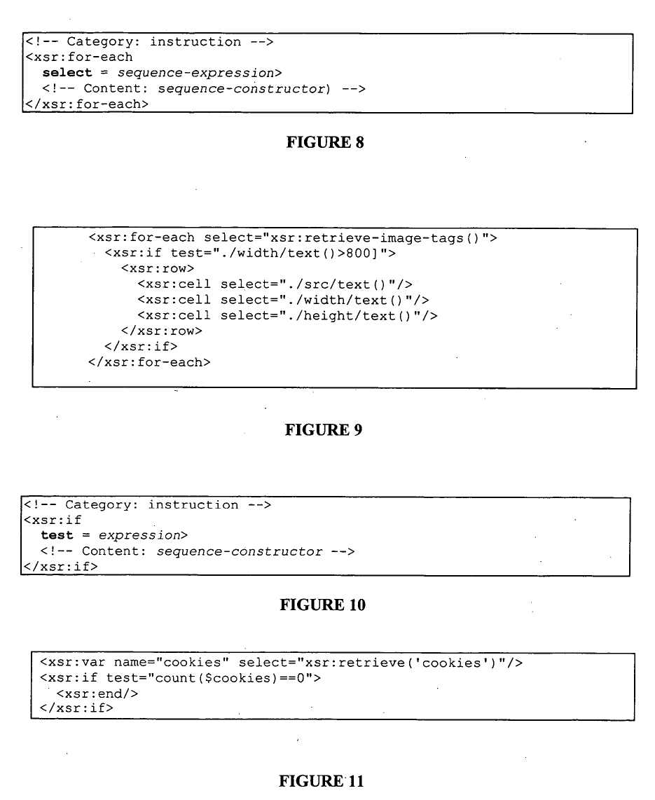

Exemplary coding to implement “for-each looping” is presented in FIG. 8. The xsr:for-each instruction processes each item in a sequence of items, evaluating the child elements within the xsr:for-each instruction once for each item in that sequence. The select attribute is required, and the XPath expression must evaluate to a sequence, called the input sequence.

The xsr:for-each instruction contains a sequence constructor, which is evaluated once for each item in the sorted sequence. The sequence constructor is evaluated with the focus set as follows:

The context item is the item being processed. If this is a node, it will also be the context node. If it is not a node, there will be no context node: that is, the value of self: :node( ) will be an empty sequence.

The context position is the position of this item in the sequence.

The context size is the size of the sequence (which is the same as the size of the input sequence).

An exemplary XRule fragment that detects images with a width greater than 800 px is presented in FIG. 9.

Conditional Processing: If

Exemplary coding to implement an “if” condition is presented in FIG. 10. The xsr:if element has a test attribute, which specifies an expression. The content is a sequence constructor.

The result of the xsr:if instruction depends on the effective boolean value of the expression in the test attribute. The rules for determining the effective boolean value of an expression are given in XPath 2.0: they are the same as the rules used for XPath conditional expressions.

If the effective boolean value of the expression is true, then the sequence constructor contained by the xsr:if instruction is evaluated. If the effective boolean value of the expresion is false, the contents of the xsr:if instruction are not evaluated and the runtime's cursor moves to the next element. For example, an XRule fragment that fast-exits execution of an XRule if the page being evaluated has no cookies, is presented in FIG. 11.

Conditional Processing: Choose

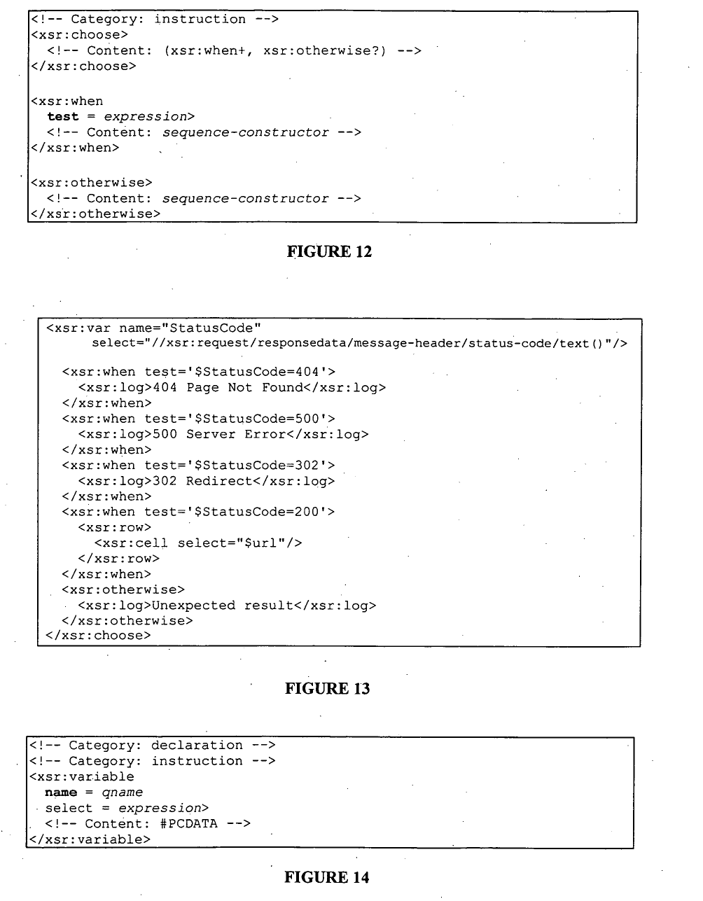

Exemplary coding to implement a “choose” condition is presented in FIG. 12. The xsr:choose element selects one among a number of possible alternatives. It consists of a sequence of xsr:when elements followed by an optional xsr:otherwise element. Each xsr:when element has a single attribute, test, which specifies an expression. The content of the xsr:when and xsr:otherwise elements is a sequence constructor.

When an xsr:choose element is processed, each of the xsr:when elements is tested in turn (that is, in document order as the elements appear in the stylesheet), until one of the xsr:when elements is satisfied. An xsr:when element is satisfied if the effective boolean value of the expression in its test attribute is true. The rules for determining the effective boolean value of an expression are given in XPath 2.0: they are the same as the rules used for XPath conditional expressions.

The content of the first, and only the first, xsr:when element that is satisfied is evaluated. If no xsr:when element is satisfied, the content of the xsr:otherwise element is evaluated, and the resulting sequence is returned as the result of the xsr:choose instruction. If no xsr:when element is satisfied, and no xsr:otherwise element is present, the result of the xsr:choose instruction is an empty sequence.

Only the sequence constructor of the selected xsr:when or xsr:otherwise instruction is evaluated. The test expressions for xsr:when instructions after the selected one are not evaluated.

The exemplary code in FIG. 13 logs a message or writes a row to the database, depending on the outcome or a request.

Variables: Variable

Exemplary coding for declaring variables is presented in FIG. 14. The xsr:variable element has a required name attribute, which specifies the name of the variable. The value of the name attribute is a QName, which is expanded as described in the Terminology section above.

The initial value of the variable is computed using the expression given in the select attribute and/or the contained sequence constructor. This value is referred to as the supplied value of the variable.

A variable-binding element can specify the value of the variable in three alternative ways:

If the variable-binding element has a select attribute, then the value of the attribute must be an expression and the value of the variable is the object that results from evaluating the expression. In this case, the content must be empty.

If the variable-binding element does not have a select attribute and has non-empty content (i.e. The variable-binding element has one or more child nodes), then the content of the variable-binding element specifies the value. The content of the variable-binding element is text that becomes the value of the variable.

If the variable-binding element has empty content and does not have a select attribute, then the value of the variable is an empty string. Thus, <xsl:variable name=“x”/> is equivalent to: <xsl:variable name=“x” select=“″”/>.

Variables are scoped by their placement within the XRule XML. For any variable-binding element, there is a region of the XRule within which the binding is visible. The set of variable bindings in scope for an XPath expression consists of those bindings that are visible at the point in the XRule where the expression occurs. A variable binding element is visible for all following siblings and their descendants. Unlike XSLT, variables may be assigned a new value using the update-variable operator.

It is a dynamic error to specify a variable using a QName used by another variable currently in scope.

The value of the variable is evaluated by the runtime when the variable binding element is processed by the runtime. If the select attribute is used, the XPath expression is evaluated at that time.

In XSLT, there is the possibility of creating a circular reference using variables. In XSLT and XRules this is a dynamic error. Because of the reduced functionality of the variable binding element in XRules, and because the XPath expression in the select attribute is evaluated before the variable is registered, the potential for creating circularity is diminished, perhaps eliminated, and is certainly avoidable.

Variables: Update-Variable

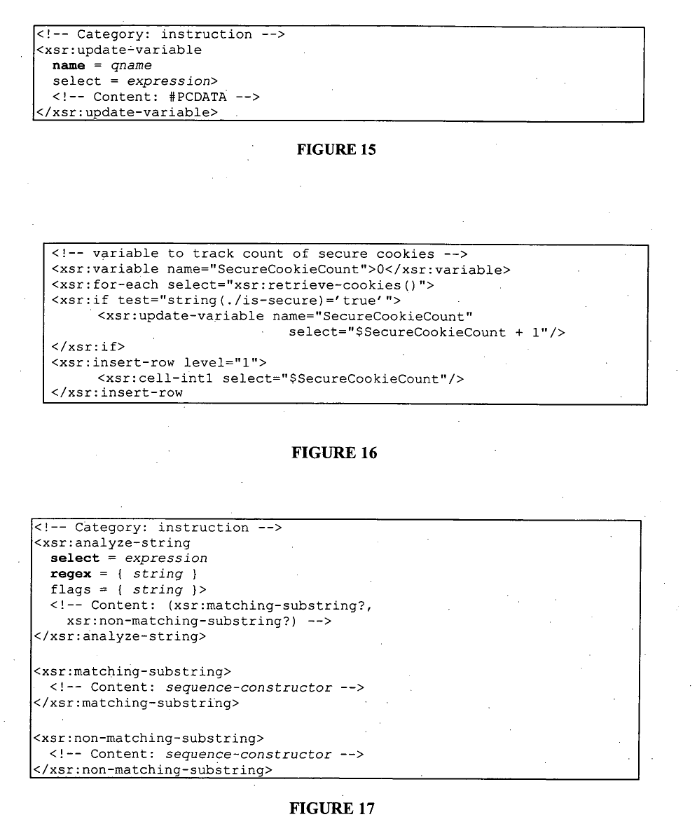

Exemplary coding for updating variables is presented in FIG. 15. The xsr:update-variable element has a required name attribute, which specifies the name of the variable. The value of the name attribute is a QName, which is expanded as described in the Terminology section above.

It is a dynamic error if the xsr:update-variable element specifies a variable that is not currently in scope.

The new value of the variable is computed using the expression given in the select attribute or the contained sequence constructor. Subsequent evaluations of the variable will retrieve the value provided by the most recent xsr:update-variable instruction.

Exemplary coding to update a “cookie counting” variable is presented in FIG. 16.

Regular Expressions: Analyze-String

The xsr:analyze-string instruction takes as input a string (the value of the select attribute) and a regular expression (the effective value of the regex attribute). Exemplary coding is presented in FIG. 17.

The flags attribute may be used to control the interpretation of the regular expression. If the attribute is omitted, the effect is the same as supplying a zero-length string. This is interpreted in the same way as the $flags attribute of the functions xsr:matches, xsr:replace, and xsr:tokenize.

Specifically, if it contains the letter “m”, the match operates in multiline mode, otherwise it operates in string mode. If it contains the letter “i”, it operates in case-insensitive mode, otherwise it operates in case-sensitive mode. For more detailed specifications of these modes, see Microsoft .Net Regular Expressions references.

Note: Because the “regex” attribute is not an attribute value template as it is in XSLT, curly braces within the regular expression must not be doubled. For example, to match a sequence of one to five characters followed by whitespace, write regex=“.{1,5}\s”, not regex=“.{{1,5}}\s” as is necessary in XSLT.

The xsr:analyze-string instruction may have two child elements: xsr:matching-substring and xsr:non-matching-substring. Both elements are optional, and neither may appear more than once.

This instruction is designed to process all the non-overlapping substrings of the input string that match the regular expression supplied.

It is a dynamic error if the effective value of the regex attribute does not conform to the required syntax for regular expressions, as specified in the Microsoft .Net Regular Expressions references, or if the effective value of the flags attribute has a value other than “i”, “m” or “im”. The runtime must signal the error. If the regular expression and/or flags are known statically (for example, if the attributes do not contain any expressions enclosed in curly braces) then the runtime may signal the error as a static error.

It is a dynamic error if the effective value of the regex attribute is a regular expression that matches a zero-length string. The processor must signal the error. If the regular expression is known statically (for example, if the attribute does not contain any expressions enclosed in curly braces) then the processor may signal the error as a static error.

The xsr:analyze-string instruction starts at the beginning of the input string and attempts to find the first substring that matches the regular expression. If there are several matches, the first match is defined to be the one whose starting position comes first in the string. Having found the first match, the instruction proceeds to find the second and subsequent matches by repeating the search, starting at the first character that was not included in the previous match.

The input string is thus partitioned into a sequence of substrings, some of which match the regular expression, others which do not match it. Each substring will contain at least one character. This sequence of substrings is processed using the xsr:matching-substring and xsr:non-matching-substring child instructions. A matching substring is processed using the xsr:matching-substring element, a non-matching substring using the xsr:non-matching-substring element. Each of these elements takes a sequence constructor as its content. If the element is absent, the effect is the same as if it were present with empty content. In processing each substring, the contents of the substring will be the context item (as a value of type xs:string); the position of the substring within the sequence of matching and non-matching substrings will be the context position; and the number of matching and non-matching substrings will be the context size.

If the input is a zero-length string, the number of substrings will be zero, so neither the xsr:matching-substring nor xsr:non-matching-substring elements will be evaluated.

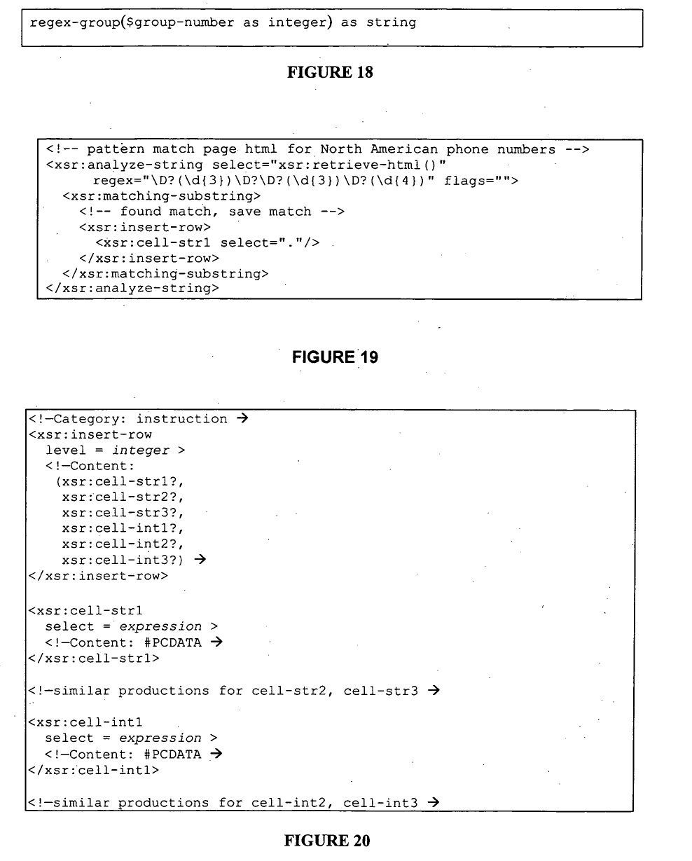

While the xsr:matching-substring instruction is active, a set of captured substrings is available, corresponding to the parenthized sub-expressions of the regular expression. These captured substrings are accessible using the function regex-group (see exemplary coding in FIG. 18). This function takes an integer argument to identify the group, and returns a string representing the captured substring. In the absence of a captured substring with the relevant number, it returns the zero-length string.

Note: The function also returns a zero-length string in the case of a group that matched a zero-length string, and in the case of a group that exists in the regular expression but did not match any part of the input string.

Put another way, the XPath expression regex-group, for the set of all matching substrings, returns the substring whose index matches the integer parameter you pass in.

While no xsr:matching-substring instruction is active the regex-group returns an empty sequence. The function also returns an empty sequence if an xsr:non-matching-substring instruction has been activated more recently than an xsr:matching-substring instruction.

For example, consider the XRule fragment in FIG. 19, that pattern matches the HTML of a page for North American phone numbers. Matches are saved to the database, and non-matches are of no interest.

Output to Database: Insert-Row

The xsr:insert-row instruction is used to add data to the WebXM database. Exemplary coding is presented in FIG. 20.

The level attribute may be used to control the default presentation of this data. The level attribute must have the value of 1 or 2 for standard reporting, however, other integer values may be specified if the XRule data will be displayed exclusively with custom reports. If unspecified, 1 is the default value. When the effective value of the level attribute is 1 the row of data is displayed at the top level of the report. When the level attribute is 2 the row of data is displayed in the second level of the report.

The top level of the report always shows the URL of the page for which this XRule has found an issue along with any other string or integer data added to the row. The second level of the report displays the string and integer data in the row. In order for second level data to be accessible in the report, a top level row must be added whenever second level rows are added.

The xsr:insert-row instruction may have as many as six child elements: xsr:cell-str1, xsr:cell-str2, xsr:cell-str3 are used to add textual data to the database; while xsr:cell-int1, xsr:cell-int2, xsr:cell-int3 are used to add integer data to the database.

If the xsr:cell-X instruction has a select attribute, then the value of the attribute must be an expression and the result of evaluating the expression is inserted into the database. In this case, the content must be empty.

If the xsr:cell-X instruction does not have a select attribute and has non-empty content, then the content of the element specifies the value. The content of the element is inserted into the database.

It is a static error if the xsr:cell-X instruction contains both a select attribute and content.

The xsr:cell-str1, xsr:cell-str2, xsr:cell-str3 instructions treat their data as a string with maximum length of 1024 characters. Strings longer that 1024 characters are truncated to 1024 characters.

The xsr:cell-int1, xsr:cell-int2, xsr:cell-int3 instructions convert their data to an integer. The value of the integer must be in the range of negative 2,147,483,648 through positive 2,147,483,647.

A dynamic error is reported if the provided data cannot be converted to an integer, or if the integer falls outside the allowed range. To parse correctly as an integer, the supplied data must have the following form: [ws][sign]digits[ws]

Items in square brackets ([and]) are optional; and the values of the other items are as follows:
ws—An optional white space.
sign—An optional sign.
digits—A sequence of digits ranging from 0 to 9.

For effective report display, XRule authors are encouraged to begin using the lowest numbered instructions, xsr:cell-str1 and xsr:cell-int1, placing data in the higher numbered locations only after the lower numbered locations have already been used.

When a new row is created, some cells are added to each row implicitly:

UrlId, the identifier of the page url is added so that XRule data may be associated with the current page in the report.

ScanRuleld, the identifier for the XRule, so that data gathered by various XRules may be distinguished.

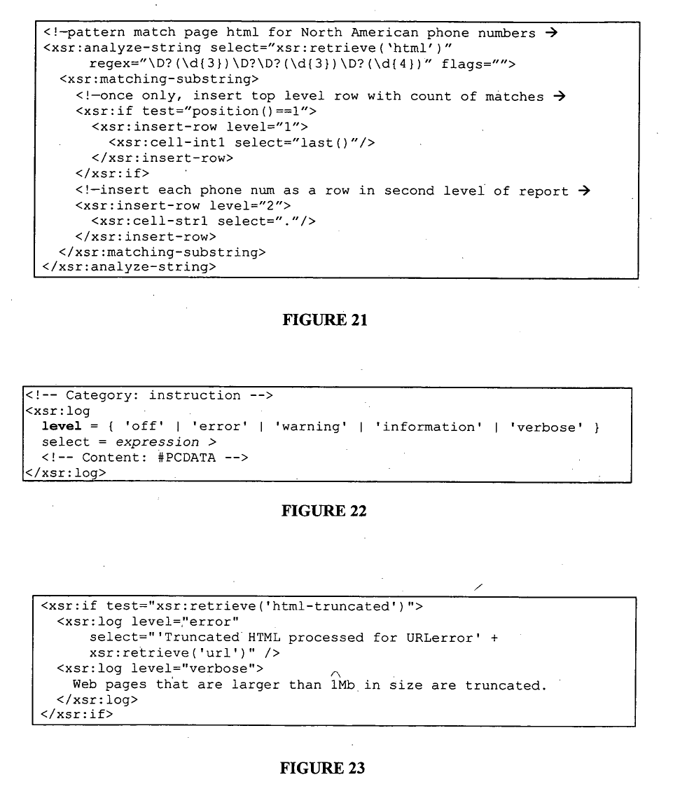

For example, consider the XRule in FIG. 21 that pattern matches the HTML of a page for North American phone numbers and saves matches in such a form that it can be displayed as a two level report. The top level of the report will be the list of pages containing phone numbers, and the url and count of phone numbers found is shown. The second level will be the list of phone numbers found on the page.

Output to Logfile: Log

The xsr:log instruction is used to log messages to the WebXM log. Exemplary coding is presented in FIG. 22. The xsr:log element has a required level attribute, which specifies the minimum logging level setting required in order to log the message. The following are acceptable values, in order of most restrictive to least restrictive: off, error, warning, information, verbose.

When the level attribute is set to error, the message will be logged if the current logging level (a WebXM registry setting) is error, warning, information or verbose. When the level attribute is set to information, the message will be logged if the current logging level (a WebXM registry setting) is information or verbose.

If the xsr:log instruction has a select attribute, then the value of the attribute must be an expression and the result of evaluating the expression will be logged. In this case, the content must be empty.

If the xsr:log instruction does not have a select attribute and has non-empty content, then the content of the variable-binding element specifies the value. The content of the element is inserted into the database.

It is a static error if the xsr:log instruction contains both a select attribute and content.

For example, an XRule fragment that logs an error if the HTML has been truncated and additional information when the verbose setting is enabled, is presented in FIG. 23.

Specifying Column Headings: Column-Heading-Strings and Column-Heading-Keys

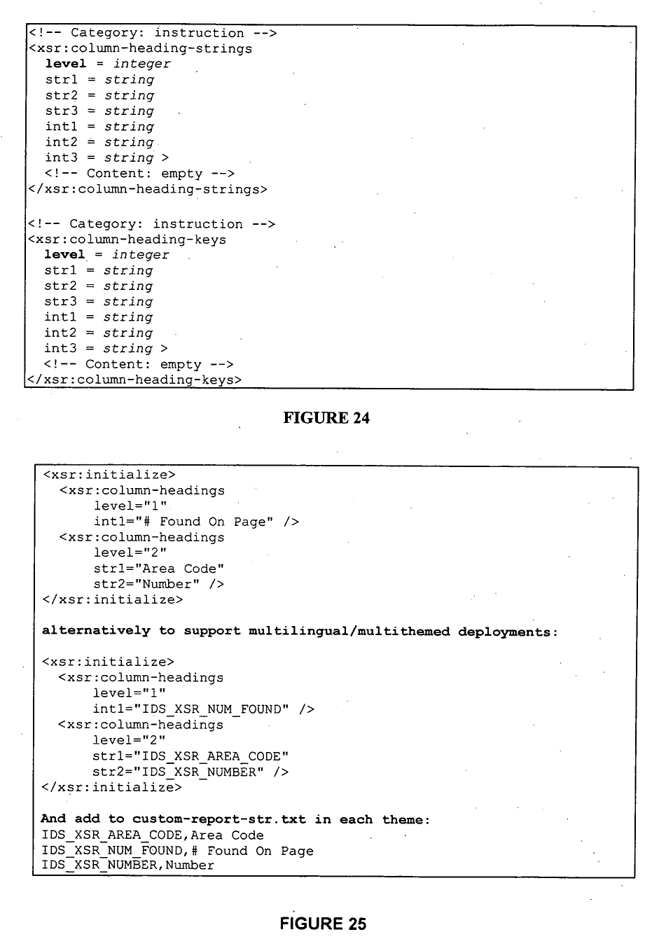

The xsr:column-heading-strings instruction is used to specify the headings for the columns to be displayed in a report. Exemplary coding is presented in FIG. 24.

Alternatively, the xsr:column-heading-keys instruction may be used to specify the headings for the columns to be displayed in a report. When the column headings need to appear in different languages for different users, this alternative must be used. At runtime, the Webapp will use the provided keys to lookup the displayable string using the theme of the current user. The string resources corresponding to the keys must be added to the strings.txt file, or another strings resource file, in the themes directory of the Webapp.

The xsr:column-heading-strings and xsr:column-heading-keys instructions are valid in the xsr:initialize section of the XRule.

Both xsr:column-heading-strings and xsr:column-heading-keys elements have a required level attribute, which is used to indicate which level of the report the column headings should be used for. The level attribute must have the value of 1 or 2 for standard reporting, however, other integer values may be specified if the XRule data will be displayed exclusively with custom reports.

Other attributes are optional and may contain a string of up to 255 characters in length.

For example, an XRule fragment that specifies column names for the first and second levels of a report that has as the first level a list of urls with a number of phone numbers found on the page, and as a second level a list of all the area codes and phone numbers found on the page, is presented in FIG. 25.

Describing an XRule: Annotation

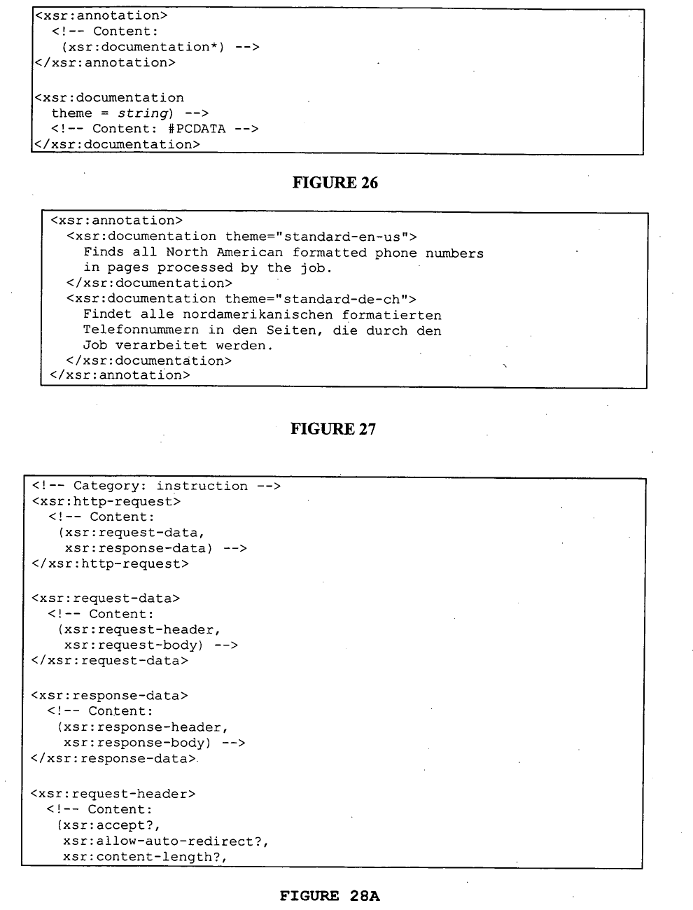

The xsr:annotation element is used annotate an XRule. The xsr:documentation element is intended to contain descriptive text for the benefit of human readers. Exemplary coding is presented in FIG. 26.

The xsr:documentation element has an optional theme attribute. If specified, the user agent (the Webapp) will attempt to locate a version of the documentation suitable for the current theme.

The Webapp will display the contents of the xsr:documentation element in the read-only properties page for a job.

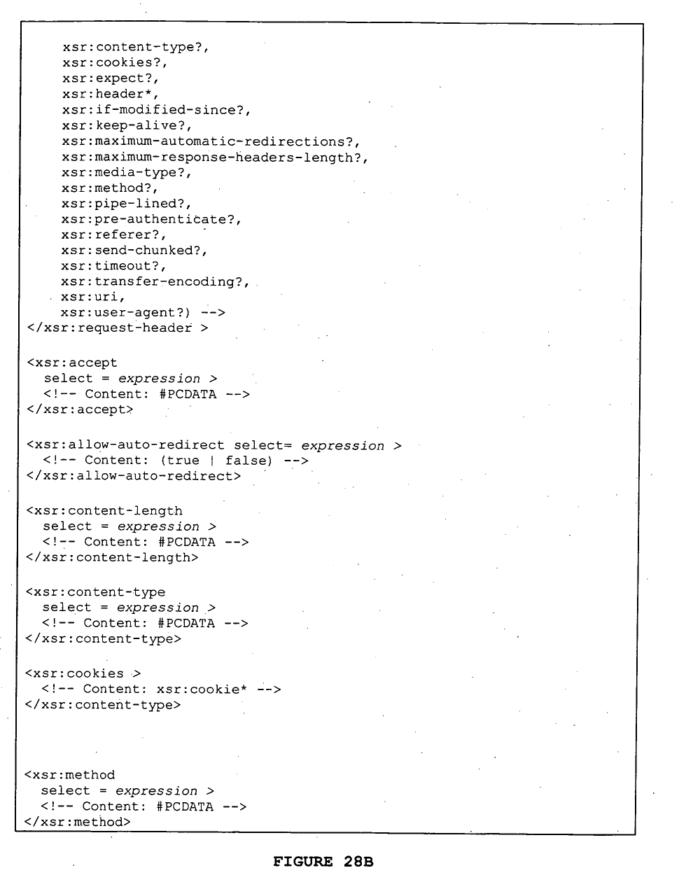

For example, an XRule fragment that finds all North American telephone numbers is presented in FIG. 27.

Accessing the Web: http-Request

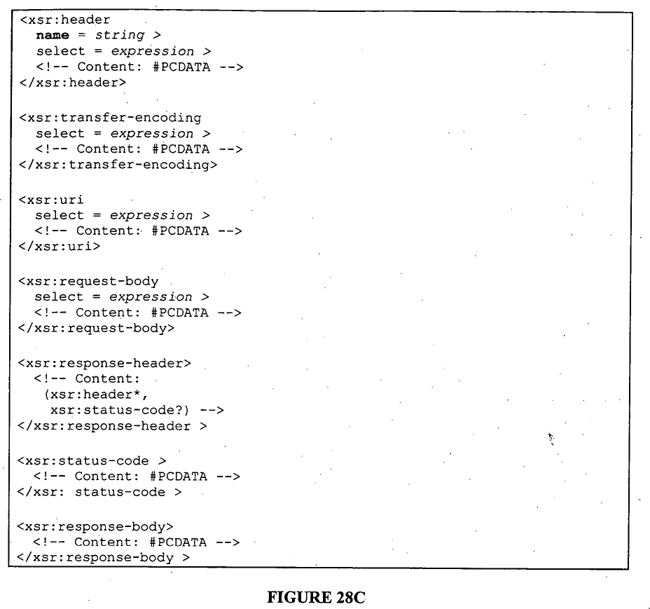

The xsr:http-request instruction is used to retrieve data from the Web for processing in the XRule. Exemplary coding is presented in FIGS. 28A through 28C.

The xsr:http-request element must contain xsr:request-data and xsr-response-data elements. The xsr:request-data element contains all data specified as part of the HTTP request. The xsr:response-data element is used to identify the desired data to make available from the HTTP response, and also to contain that data. The initially empty elements in xsr:response-data are populated once the data becomes available and before processing of the xsr:http-request instruction is complete. Items are populated by adding a text-node containing the data as a child.

It is a static error if the xsr:request-data element does not contain a xsr:request-header element that contains a xsr:uri element. It is a dynamic error if a uri is not specified by either the select or the content of the xsr:uri instruction.

For instructions that allow a “select” attribute and #PCDATA content, it is a dynamic error if both are specified (as it is for xsr:variable and others).

Instructions map directly to properties of the System.Net.HttpWebRequest and System.Net.HttpWebResponse classes. It may be useful to refer to the documentation for those classes to infer the semantics and valid values for the various instructions:
http://msdn.microsoft.com/library/default.asp?url=/library/enus/cpref/html/frlrfsystemnethttpWebrequestmemberstopic.asp

There are many other properties that one might like to set on the System.Net.HttpWebRequest class, or access on the System.Net.HttpWebResponse class that have not been described herein. The implementation of these would be straightforward to one skilled in the art from the teachings herein. These could be placed in the core tag library or provided as sample code for creating extension operations.

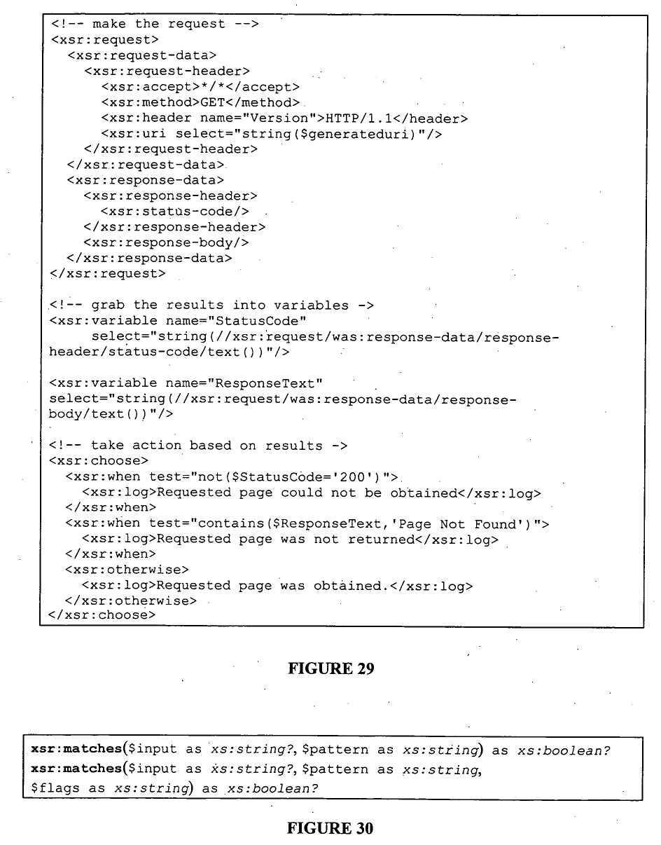

For example, an XRule fragment that requests a page, and logs a message based on the response, is presented in FIG. 29.

Core XPath Extension Functions

Testing for Match: Matches

Exemplary coding to test for matches is presented in FIG. 30. The effect of calling the first version of this function (omitting the argument $flags) is the same as the effect of calling the second version with the $flags argument set to a zero-length string. If $input is the empty sequence, the result is the empty sequence. The function returns true if $input matches the regular expression supplied as $pattern; otherwise, it returns false.

Unless the metacharacters \hat{ } and $ are used as anchors, the string is considered to match the pattern if any substring matches the pattern. But if anchors are used, the anchors must match the start/end of the string (in string mode), or the start/end of a line (in multiline mode).

A dynamic error is raised (“Invalid regular expression”) if the value of $pattern is invalid according to the rules described in the Microsoft .Net Regular Expressions references. Similarly, a dynamic error is raised (“Invalid regular expression flags”) if the value of $flags is invalid according to the rules described in the Microsoft .Net Regular Expressions references.

For example:
fn:matches(“abracadabra”, “bra”) returns true
fn:matches(“abracadabra”, “\hat{ }a.*a$”) returns true
fn:matches(“abracadabra”, “\hat{ }bra”) returns false

Note: This function is syntactically and functionally equivalent to the matches function described in “XQuery 1.0 and XPath 2.0 Functions and Operators W3C Working Draft 2 May 2003” and will eventually be replaced by core functionality offered by the XPath processor.

String Replacements: Replace

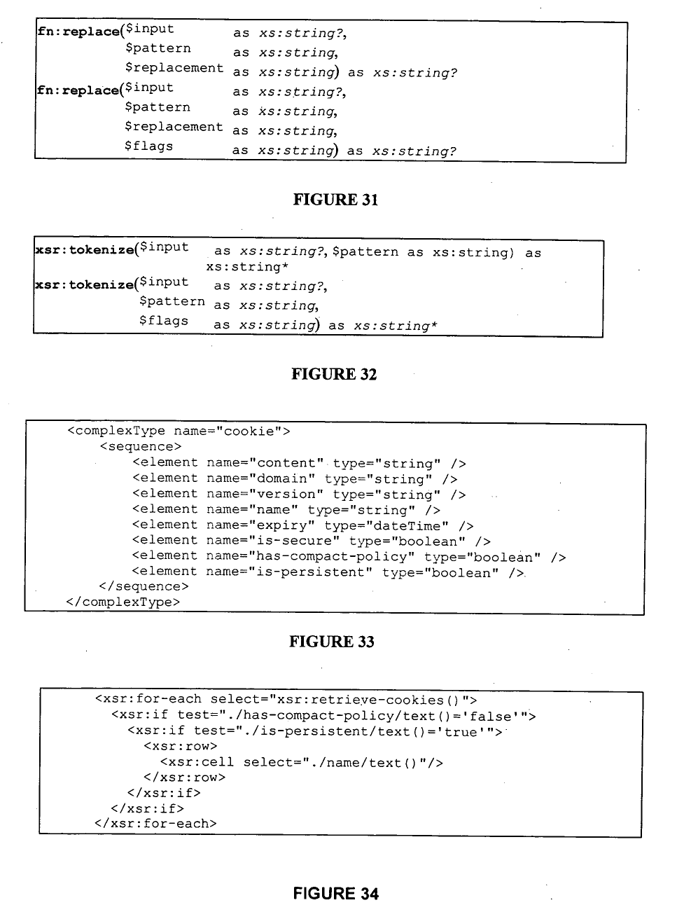

Exemplary coding to implement string replacements is presented in FIG. 31.

The effect of calling the first version of this function (omitting the argument $flags) is the same as the effect of calling the second version with the $flags argument set to a zero-length string. The $flags argument is interpreted in the same manner as for the xsr:matches( ) function.

If $input is the empty sequence, the result is the empty sequence. The function returns the xs:string that is obtained by replacing all non-overlapping substrings of $input that match the given $pattern with an occurrence of the $replacement string.

If two overlapping substrings of $input both match the $pattern, then only the first one (that is, the one whose first character comes first in the $input string) is replaced. Within the $replacement string, the variables $1 to $9 may be used to refer to the substring captured by each of the first nine parenthesized sub-expressions in the regular expression. A literal $ symbol must be written as \$. For each match of the pattern, these variables are assigned the value of the content of the relevant captured sub-expression, and the modified replacement string is then substituted for the characters in $input that matched the pattern.

If a variable $n is present in the replacement string, but there is no nth captured substring (which may happen because there were fewer than n parenthesized sub-expressions, or because the nth parenthesized sub-expression was not matched) then the variable is replaced by a zero-length string.

If two alternatives within the pattern both match at the same position in the $input, then the match that is chosen is the one matched by the first alternative. For example:
fn:replace(“abcd”, “(ab)|(a)”, “[1=$1][2=$2]”) returns “[1=ab][2=]cd”.

A dynamic error is raised (“Invalid regular expression”) if the value of $pattern is invalid according to the rules described in the Microsoft .Net Regular Expressions references.

A dynamic error is raised (“Invalid regular expression flags”) if the value of $flags is not one of ‘i’, ‘m’ or ‘im’.

A dynamic error is raised (“Regular expression matches zero-length string”) if the pattern matches a zero-length string. It is not an error, however, if a captured substring is zero-length.

A dynamic error is raised (“Invalid replacement string”) if the value of $replacement contains a “$” character that is not immediately followed by a digit 1-9 and not immediately preceded by a “/”. A dynamic error is raised (“Invalid replacement string”) if the value of $replacement contains a “\” character that is not part of a “\\” pair, unless it is immediately followed by a “$” character.

For example:
replace(“abracadabra”, “bra”, “*”) returns “a*cada*”
replace(“abracadabra”, “a.*a”, “*”) returns “*”
replace(“abracadabra”, “a.*?a”, “*”) returns “*c*bra”
replace(“abracadabra”, “a”, 37 ”) returns “brcdbr”
replace(“abracadabra”, “a(.)”, “a$1$1”) returns “abbraccaddabbra”
replace(“abracadabra”, “.*?”, “$1”) raises an error, because the pattern matches the zero-length string

Note: This function is syntactically and functionally equivalent to the replace function described in “XQuery 1.0 and XPath 2.0 Functions and Operators W3C Working Draft 02 May 2003” and will eventually be replaced by core functionality offered by the XPath processor.

Splitting a String into Substrings: Tokenize

Exemplary coding to split a string into substrings is presented in FIG. 32. The effect of calling the first version of this function (omitting the argument $flags) is the same as the effect of calling the second version with the $flags argument set to a zero-length string.

This function breaks the $input string into a sequence of strings, treating any substring that matches $pattern as a separator. The separators themselves are not returned.

The $flags argument is interpreted in the same way as for the xsr:matches( ) function.

If $input is the empty sequence, the result is the empty sequence.

If the supplied $pattern matches a zero-length string, the xsr:tokenize( ) function breaks the string into its component characters. The nth character in the $input string becomes the nth string in the result sequence; each string in the result sequence has a string length of one.

If a separator occurs at the start of the $input string, the result sequence will start with a zero-length string. Zero-length strings will also occur in the result sequence if a separator occurs at the end of the $input string, or if two adjacent substrings match the supplied $pattern.

If two alternatives within the supplied $pattern both match at the same position in the $input string, then the match that is chosen is the first. For example:
xsr:tokenize(“abracadabra”, “(ab)|(a)”) returns (“”, “r”, “c”, “d”, “r”, “”).

A dynamic error is raised (“Invalid regular expression”) if the value of $pattern is invalid according to the rules described in the Microsoft .Net Regular Expressions references. A dynamic error is raised (“Invalid regular expression flags”) if the value of $flags is not one of ‘i’, ‘m’ or ‘im’.

For example:
xsr:tokenize(“The cat sat on the mat”, “\s+”) returns (“The”, “cat”, “sat”, “on”, “the”, “mat”)
xsr:tokenize(“1, 15, 24, 50”, “,\s*”) returns (“1”, “15”, “24”, “50”)
xsr:tokenize(“1,15,24,50,”, “,”) returns (“1”, “15”, “”, “24”, “50”, “”)
xsr:tokenize(“Some unparsed <br> HTML <BR> text”, “\s*<br>\s*”, “i”) returns (“Some unparsed”, “HTML”, “text”)

Note: This function is syntactically and functionally equivalent to the tokenize function described in “XQuery 1.0 and XPath 2.0 Functions and Operators W3C Working Draft 02 May 2003” and will eventually be replaced by core functionality offered by the XPath processor.

Retrieving Substring Matches: Regex-Group

The format for this command is as follows:
xsr:regex-group($group-number as xs:integer?) as xs:string?

The functionality is basically the same as that described in xsr:analyze-string.

Obtaining HTML: Retrieve-Html

This function is used to obtain the HTML of the page in an XRule. The format for this command is as follows:
xsr:retrieve-html( ) as xs:string?

Some maximum limit is imposed on the size of the HTML that can be retrieved. To determine if the HTML this function provides is complete or truncated, use the function xsr:retrieve-html-truncated.

Determining if HTML is Complete: Retrieve-Html-Truncated

This function is used to determine if a call to retrieve-html while evaluating the current page with return the complete HTML of the page or a truncated version. The format for this command is as follows:
xsr:retrieve-html-truncated( ) as xs:boolean?

The function returns true if the HTML has been truncated, false otherwise.

Obtaining Text: Retrieve-Text

This function is used to obtain the text of the page in an XRule. The format for this command is as follows:
xsr:retrieve-text( ) as xs:string?

Some maximum limit is imposed on the size of the text that can be retrieved. To determine if the text this function provides is complete or truncated, use the function xsr:retrieve-text-truncated.

Determining if Text is Complete: Retrieve-Text-Truncated

This function is used to determine if a call to retrieve-text while evaluating the current page with return the complete text of the page or a truncated version. The format for this command is as follows:
xsr:retrieve-text-truncated( ) as xs:boolean?

The function returns true if the text has been truncated, false otherwise.

Obtaining Form HTML: Retrieve-Formhtml

This function is used to obtain the HTML contained with forms on the page. The format for this command is as follows:
xsr:retrieve-form-html( ) as xs:string?

Some maximum limit is imposed on the size of the HTML that can be retrieved. To determine if the HTML this function provides is complete or truncated, use the function xsr:retrieve-form-html-truncated.

Determining if Form HTML is Complete: Retrieve-Formhtml-Truncated

This function is used to determine if a call to retrieve-formhtml while evaluating the current page with return the complete form HTML of the page or a truncated version. The format for this command is as follows:
xsr:retrieve-form-html-truncated( ) as xs:boolean?

The function returns true if the form HTML has been truncated, false otherwise.

Obtaining the URL of the Page: Retrieve-Url

This function is used to obtain the URL used to retrieve the current page. The format for this command is as follows:
xsr:retrieve-url( ) as xs:string?

Obtaining Request Post Data: Retrieve-Post-Data

This function is used to obtain the post data sent when the current page was requested. The format for this command is as follows:
xsr:retrieve-post-data( ) as xs:string?

Obtaining Request Headers: Retrieve-Headers

This function is used to obtain the headers sent when the current page was requested. The format for this command is as follows:
xsr:retrieve-headers( ) as xs:string?

Obtaining Mime Type of Page: Retrieve-Mime-Type

This function is used to obtain the mime-type of the current page. The format for this command is as follows:
xsr:retrieve-mime-type( ) as xs:string?

Obtaining Status Line of Page: Retrieve-Status-Line

This function is used to obtain the status line returned in the response for the current page. The format for this command is as follows:
xsr:retrieve-status-line( ) as xs:string?

Determining if Page is Internal: Retrieve-is-Internal

This function is used to obtain determine if the current page is considered to be an internal page by the scan engine. The format for this command is as follows: xsr:retrieve-is-internal( ) as xs:boolean?

Determining if Page Contains Frameset: Retrieve-has-Frameset

This function is used to obtain determine if the current page contains a frameset. The format for this command is as follows:
xsr:retrieve-has-frameset( ) as xs:boolean?

Determining if Page Contains JavaScript: Retrieve-has-Javascript

This function is used to obtain determine if the current page contains JavaScript method calls. The format for this command is as follows:
xsr:retrieve-has-javascript( ) as xs:boolean?

Obtaining the Cookies: Retrieve-Cookies

This function is used to obtain the set of cookies for the page. The format for this command is as follows:
xsr:retrieve-cookies( ) as node*

The cookies are returned as a collection of cookie XML elements of the type described by the XML schema complexType, as presented in FIG. 33.

For example, an XRule fragment which retrieves the cookies for the page and reports any cookies that are persistent and do not have a compact policy, is presented in FIG. 34.

Obtaining Image Tags: Retrieve-Image-Tags

This function is used to obtain the set of image tags on the page. The format for this command is as follows:
xsr:retrieve-image-tags( ) as node*

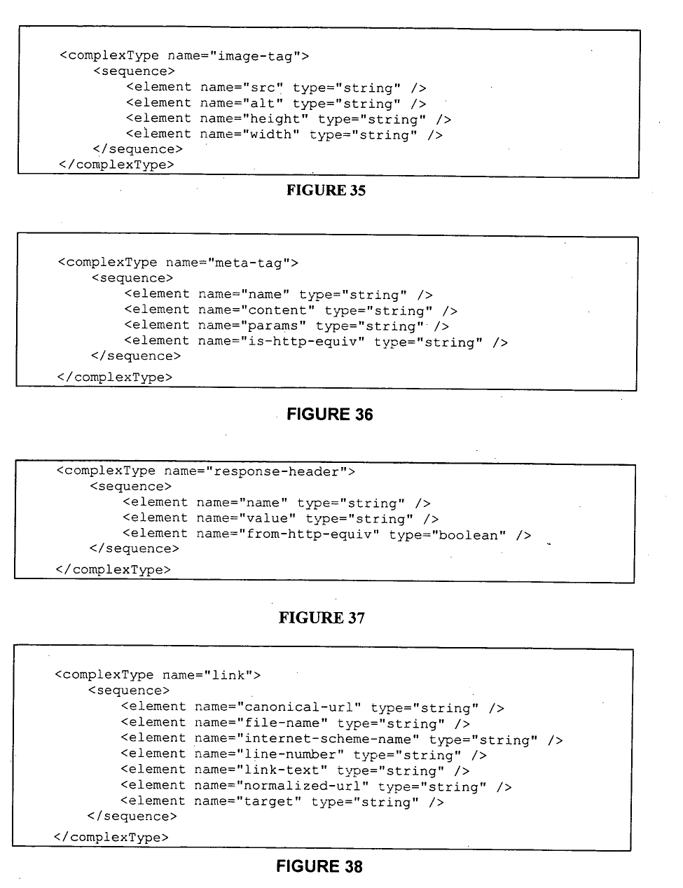

The image tags are returned as a collection of image-tag XML elements of the type described by the XML schema complexType presented in FIG. 35.

For an example of usage, see the description of xsr:for-each.

Obtaining Meta Tags: Retrieve-Meta-Tags

This function is used to obtain the set of meta tags on the page. The format for this command is as follows:
xsr:retrieve-meta-tags( ) as node*

The image tags are returned as a collection of meta-tag XML elements of the type described by the XML schema complexType presented in FIG. 36.

Obtaining Response Headers: Retrieve-Response-Headers

This function is used to obtain the set of response headers for the page. The format for this command is as follows:
xsr:retrieve-response-headers( ) as node*

The response headers are returned as a collection of response-header XML elements of the type described by the XML schema complexType as presented in FIG. 37.

Obtaining Links on Page: Retrieve-Links

This function is used to obtain the set of links found on the page. The format for this command is as follows:
xsr:retrieve-links( ) as node*

The links are returned as a collection of link XML elements of the type described by the XML schema complexType, as presented in FIG. 38.

Obtaining Parsed Form Data on Page: Retrieve-Forms

This function is used to obtain the set of form information found on the page. The format for this command is as follows:
xsr:retrieve-forms( ) as node*

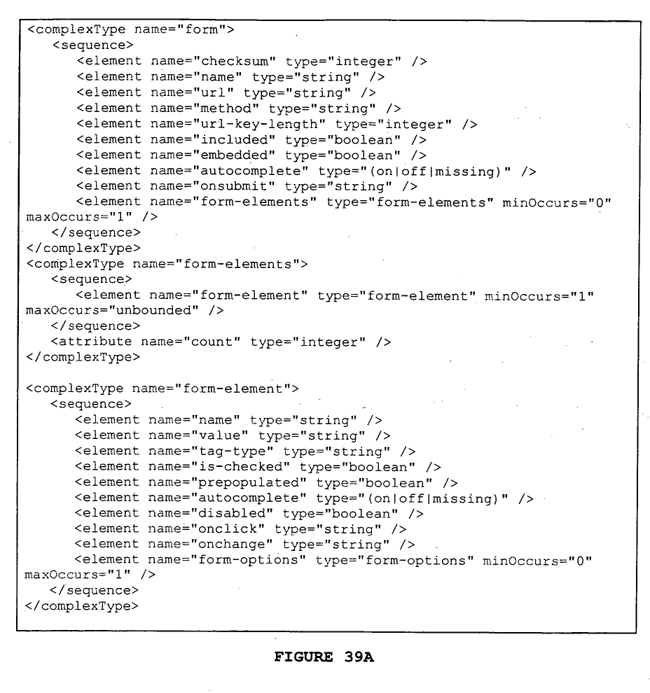

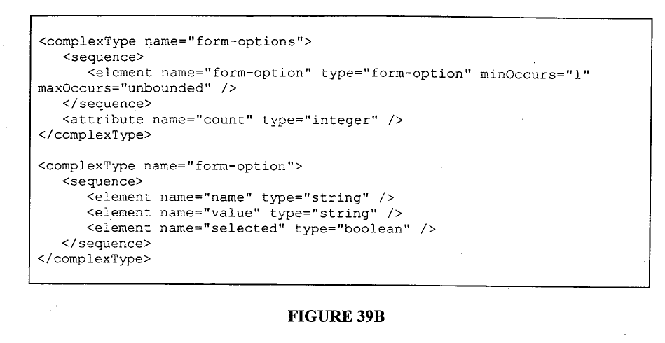

The forms found are returned as a collection of form XML elements of the type described by the XML schema complexType as presented in FIGS. 39A and 39B.

Limitations

Maximum Page Size Limitation

In order to simplify the XRule programming model, and to facilitate the use of regular expressions, XRules processes HTML page input as a string, not a stream. Elsewhere the scan engine processes pages as streams.

This implies that the stream is gathered into a string at some point. Some limit must be placed on the maximum size of page that can be processed without truncation by XRules.

The maximum size for pages must balance system resource usage against the number of pages that are truncated. For XRules to be effective, very few pages should be truncated. The maximum page size without truncation should be governed by a registry setting, perhaps ˜1 MB. This figure is going to change over time as the speed, processing power and strange capacity of computers and servers improves.

Whether or not the page has been truncated must be provided as input to an XRule. The XRule can then take the appropriate action for truncated pages. For instance, some XRules may wish to ignore the fact that a page was truncated and proceed with the test normally, using the truncated content. Other XRules may wish to flag all truncated pages as pages potentially containing issues.

Localized Column Headers

Most strings that appear in the Webapp come from string resources—the strings.txt and report-str.txt files. String resources combined with the themes support constitutes the localization strategy for the Webapp. The current means of specifying column headers is not theme or locale aware. One could create an XRule that specifies the column headers in some language other than English, but this is still somewhat deficient. In theory, an instance of the Webapp could be modified to simultaneously support users in multiple different languages, whereas the XRule column headers would always be in one language, the one specified in the XRule.

The invention will first be released in the simple form, because localized versions of WebXM are not available nor are customers running multiple UI languages at once. The solution for the advanced solution is somewhat complex.

We can add the more complex solution in a later release as needed. When specifying column headers, the text would be provided with a theme name. The theme name would be stored in the database. WEO would select the column header for the XRule, level, column and theme and generate the XML with the themized heading.

Options and Alternatives

A number of embodiments of the invention have been described, but clearly many others can be effected from the teachings herein. For example, the invention:
1. is preferably implemented as a server application but may also be PC (personal computer) based;
2. may be provided with a schedule agent so that it can run each day as a midnight batch, for instance;
3. is preferably provided with a complete development environment, which would be clear to one skilled in the art, including:
an editing environment;
an interactive regular expression authoring environment;
an interactive execution environment with step-by-step debugging; and
a performance testing environment;
4. is preferably implemented using XML as the rule specification language, but may also be implemented using JavaScript, VBScript, Perl or another script-based or compiled programming language; and
5. is ideally suited to analysis on web site content for security, privacy, accessibility, quality and compliance related issue detection, but could be also applied to other types of analysis of web sites.

The present invention has been described with regard to one or more embodiments. However, it will be apparent to persons skilled in the art that a number of variations and modifications can be made without departing from the scope of the invention as defined in the claims.

The method steps of the invention may be embodiment in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory medium such computer diskettes, CD-Roms, Random Access Memory (RAM), Read Only Memory (ROM) or similar computer software storage media known in the art, may be programmed to execute such method steps. As well, electronic signals representing these method steps may also be transmitted via a communication network.

All citations are hereby incorporated by reference.

1. A method of Web site analysis comprising the steps of:
establishing parameters for search and analysis of a Web page, including customized search rules, formatted according to a defined language specification;
analyzing said Web page to identify structure and content issues, and collect data, including executing said customized search rules; and
generating a report on the results of said analysis.

2. The method of claim 1, wherein said step of analyzing further comprises the step of storing collected data on a database.

3. The method of claim 2, wherein said customized search rules include logical tests.

4. The method of claim 2, wherein said step of executing comprises the step of compiling said customized search rules.

5. The method of claim 2, wherein said step of executing comprises the step of interpreting said customized search rules.

6. The method of claim 5, further comprising the step of entering said customized search rules using a text editor.

7. The method of claim 5, further comprising the step of parsing said customized search rules.

8. The method of claim 6, wherein said customized search rules are defined in XML (extensible mark-up language code).

9. The method of claim 5, wherein said step of interpreting comprises the step of creating objects from said rules using compiled code modules.

10. The method of claim 8, wherein said step of interpreting comprises the steps of:
parsing said XML code and generating an Xpath tree; and
walking said Xpath tree and creating objects from compiled C# code.

11. The method of claim 2, wherein said step of analyzing comprises the steps of:
executing logic and matching patterns;
processing on found matches, and
inserting processed data into a database.

12. The method of claim 5 further comprising the step of:
querying the User to input parameters for said analysis.

13. The method of claim 5 wherein the software code for effecting said method comprises a Runtime Module for interpreting and executing said rules.

14. The method of claim 5 wherein the software code for effecting said method comprises an Execution Environment Module for pre-processing said rules.

15. The method of claim 5 wherein the software code for effecting said method comprises a database for storing XRules Metadata, XRules Data and XRules XML code.

16. The method of claim 5 further comprising the step of identifying Web pages which exceed a certain threshold level for certain content issues.

17. A system for analyzing a Web site, said system comprising:
a Web server;
a Content Analysis server; and
a communication network for interconnecting said Web server and said Content Analysis server;
said Web server supporting said Web site; and
said Content Analysis server being operable to:
establishing parameters for search and analysis of a Web page, including customized search rules, formatted according to a defined language specification;
analyzing said Web page to identify structure and content issues, and collect data, including executing said customized search rules; and
generating a report on the results of said analysis.
